(19) United States
(12) Patent Application Publication
(10) Pub. No.: US 2025/0204529 A1
(43) Pub. Date: Jun. 26, 2025

(54) PROCESSES FOR CRYSTALLIZATION OF AMORPHOUS PESTICIDES AND FORMULATIONS THEREOF

(71) Applicant: FMC CORPORATION, Philadelphia, PA (US)

(72) Inventors: Evan Francis KELLER, Newark, DE (US); Laibin Bruce YAN, Newark, DE (US)

(21) Appl. No.: 18/848,215

(22) PCT Filed: Mar. 22, 2023
(86) PCT No.: PCT/US2023/015847

§ 371 Date: Sep. 18, 2024

Related U.S. Application Data
(60) Provisional application No. 63/322,360, filed on Mar. 22, 2022.

(51) Int. Cl. A01N 43/88; A01N 25/04; A01N 25/32; A01N 43/56; A01P 7/04

(52) U.S. Cl. CPC A01N 43/88; A01N 25/04; A01N 25/32; A01N 43/56; A01P 7/04

(57) ABSTRACT

Described herein are processes for preparing aqueous suspensions of crystalline organic pesticides from the amorphous form thereof. Also described herein are aqueous pesticide formulations including the prepared aqueous suspensions.

### CROSS-REFERENCE TO RELATED APPLICATIONS

This application claims the benefit of U.S. Provisional Application No. 63/322,360 filed Mar. 22, 2022.

### FIELD OF DISCLOSURE

This disclosure is directed to processes for preparing aqueous suspension concentrates of crystalline organic pesticides. The processes include inducing in situ crystallization of an amorphous organic pesticide with a crystalline organic pesticide in an aqueous system.

### BACKGROUND

Suspension concentration (SC) formulations comprise crystalline solid active ingredients dispersed in water. SCs have gained popularity because of their numerous benefits, including ease of use and effectiveness, elimination of dust, and elimination of solvent hazards when compared to formulation types such as emulsifiable concentrate (EC) and wettable powder (WP) formulations.

Some pesticides are difficult to convert from amorphous to crystalline forms for use in SC formulations. Crystalline forms are preferred over amorphous forms because distinct particle size ranges and stable formulated product may be achieved. Some pesticides, such as indoxacarb, are characterized by one or more of: a very steep temperature/viscosity curve therefore mandating relatively high temperatures to achieve flowability; a lack of a distinct melting point, i.e., a large variation in melting point that is an indication that a pesticide does not crystalize readily; degradation onset at a relatively low temperature (such as about 100° C.); and slow degradation until a much higher temperature (such as about 230° C.) with nearly complete degradation at a yet higher temperature (such as about 310° C.). Prior art methods for crystallizing such pesticides typically require complex processes using non-aqueous solvents, and the resulting crystalline pesticide cost may be too high for economic use.

One alternative option is to use melts of such pesticides in forming SC formulations. Prior art melt processes for preparing SC formulations typically require forming a melt at elevated temperature (at or above 100° C.) so that the pesticide flowable, followed by dripping the melt into an aqueous solution containing SC formulation components. Problematically, it is a significant safety concern to handle molten pesticides at a temperature above 100° C. in a manufacturing process. Further problematically, addition of molten pesticide to an aqueous solution results in a high probability that incomplete crystallization will occur resulting in a significant amount of a semi-solid amorphous material which must be isolated and reworked, or discarded with the associated environmental and cost burdens. Further, amorphous pesticide may have a relatively low glass transition temperature (such as about 25-35° C.), and the presence of any amorphous pesticide in a subsequent milling step could blind the mill screen and create processing and material exposure issues due to the required equipment cleaning. Yet further problematically, pesticide decomposition by acid- or base-catalyzed aqueous phase hydrolysis may be significant due to dripping hot pesticide melt into water over a comparative long period of time followed by milling (especially at elevated temperatures) that exposes more surface area to hydrolysis conditions. Yet further problematically, SC formulations formed by the above-described hot melt drip method a prone to crystal growth when stored above about 30° C. Crystal growth negatively affects sprayability and overall product stability.

One prior art process for preparing crystalline indoxacarb described in WO 2018/137387A1 requires the use of toxic halogenated hydrocarbons for indoxacarb dissolution, and precipitation and isolation of indoxacarb therefrom.

A need therefore exists for improved processes for the preparation of aqueous suspension concentrates of crystalline organic pesticides.

### BRIEF DESCRIPTION

In one aspect, provided herein is a process of preparing an aqueous suspension of organic pesticides, the process comprising:
I) forming a mixture comprising a source of at least one amorphous organic pesticide, water, and at least one formulation additive;
II) adding at least one crystalline seed of organic pesticide to the mixture;
III) crystallizing the at least one amorphous organic pesticide;
IV) optionally homogenizing the mixture;
V) optionally milling the mixture; and
VI) optionally thickening the mixture.

In one aspect, provided herein is a process of preparing an aqueous suspension of organic pesticides, the process comprising:
I) forming a mixture comprising
   A) a formulation additive,
   B) at least one crystalline organic pesticide, and
   C) water;
II) adding at least one amorphous organic pesticide to the mixture under conditions of agitation;
III) crystallizing the at least one amorphous organic pesticide;
IV) optionally homogenizing the mixture;
V) optionally milling the mixture; and
VI) optionally thickening the mixture.

### BRIEF DESCRIPTION OF THE DRAWINGS

FIG. 1 shows the particle size distribution of a suspension concentrate of crystallized indoxacarb of the present disclosure prior to milling.

FIG. 2 shows the particle size distribution of a suspension concentrate of milled crystallized indoxacarb of the present disclosure.

FIG. 3 shows the particle size distribution of a suspension concentrate of milled crystallized indoxacarb of the present disclosure at day 0 and at 15 days after storage at room temperature.

FIG. 4 shows the particle size distribution of a suspension concentrate of milled crystallized indoxacarb of the present disclosure after two weeks of storage at room temperature, and after two weeks of storage at 54° C.

FIG. 5 shows the particle size distribution of a suspension concentrate of milled crystallized indoxacarb of the present disclosure after four weeks of storage at room temperature, and after two weeks of storage at 54° C.

FIG. 6 shows XRD patterns for prior art crystalline indoxacarb (samples 1 and 6) and crystalline indoxacarb prepared according to the examples of the present disclosure (sample 3).

FIG. 7 shows XRD patterns for a prior art crystalline indoxacarb suspension concentrate (sample 8) and crystalline indoxacarb suspension concentrates prepared according to the examples of the present disclosure (samples 2 and 9).

FIG. 8 shows XRD patterns for prior art crystalline indoxacarb (sample 1), prior art amorphous indoxacarb (sample 7), and a crystalline indoxacarb suspension concentrate prepared according to the examples of the present disclosure (sample 9).

FIG. 9 shows XRD patterns for prior art crystalline indoxacarb (top line, sample 1), crystalline indoxacarb prepared according to the examples of the present disclosure (sample 5), a prior art crystalline indoxacarb suspension concentrate (sample 8), and crystalline indoxacarb suspension concentrates prepared according to the examples of the present disclosure (samples 4 and 9).

FIG. 10 shows a DSC diagram for prior art crystalline indoxacarb (sample 1).

FIG. 11 shows a DSC diagram for a crystalline indoxacarb suspension concentrate prepared according to the examples of the present disclosure (sample 2).

FIG. 12 shows a DSC diagram for crystalline indoxacarb prepared according to the examples of the present disclosure (sample 3).

FIG. 13 shows a DSC diagram for a crystalline indoxacarb suspension concentrate prepared according to the examples of the present disclosure (sample 4).

FIG. 14 shows a DSC diagram for crystalline indoxacarb prepared according to the examples of the present disclosure (sample 5).

FIG. 15 shows a DSC diagram for prior art crystalline indoxacarb (sample 6).

FIG. 16 shows a SEM image of prior art crystalline indoxacarb (sample 1).

FIG. 17 shows a SEM image of a crystalline indoxacarb suspension concentrate prepared according to the examples of the present disclosure (sample 2).

FIG. 18 shows a SEM image of crystalline indoxacarb prepared according to the examples of the present disclosure (sample 3).

FIG. 19 shows a SEM image of a crystalline indoxacarb suspension concentrate prepared according to the examples of the present disclosure (sample 4).

FIG. 20 shows a SEM image of crystalline indoxacarb prepared according to the examples of the present disclosure (sample 5).

FIG. 21 shows a SEM image of prior art crystalline indoxacarb (sample 6).

### DETAILED DESCRIPTION OF THE DISCLOSURE

The present disclosure is generally directed to a process to convert amorphous organic pesticides in situ in an aqueous system into crystalline organic pesticides, and to prepare high load SC formulations therefrom.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed disclosure. The term “consisting essentially of” occupies a middle ground between “comprising” and “consisting of”.

Where an disclosure or a portion thereof is defined with an open-ended term such as “comprising,” it should be readily understood that (unless otherwise stated) the description should be interpreted to also describe such an disclosure using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e., occurrences) of the element or component. Therefore “a” or “an” should be read to include one or at least one, and the singular word form of the element or component also includes the plural unless the number is obviously meant to be singular.

It also is understood that any numerical range recited herein includes all values from the lower value to the upper value. For example and without limitation, a range of 1 to 10 is intended to include all sub-ranges between and including the recited minimum value of 1 and the recited maximum value of 10, that is, having a minimum value equal to or greater than 1 and a maximum value of equal to or less than 10. In a further non-limiting example, reference herein to a range of “at least 50” includes whole numbers of 50, 51, 52, 53, 54, 55, 56, 57, 58, 59, 60, etc., and fractional numbers such as 50.1, 50.2 50.3, 50.4, 50.5, 50.6, 50.7, 50.8, 50.9, etc. In a further non-limiting example, reference herein to a range of “less than 50” includes whole numbers 49, 48, 47, 46, 45, 44, 43, 42, 41, 40, etc., and fractional numbers such as 49.9, 49.8, 49.7, 49.6, 49.5, 49.4, 49.3, 49.2, 49.1, 49.0, etc. These are only examples of what is specifically intended, and all possible combinations of numerical values between and including the lowest value and the highest value enumerated are to be considered to be expressly stated in this application.

As used herein, the term “about” means plus or minus 10% of the value.

“Crystalline” in terms of the present invention means that at least 90% by weight of the pesticide compound, which is present in the aqueous suspension, is in the crystalline state and that less than 10% by weight of the pesticide compound, which is present in the aqueous suspension, is not crystalline, i.e., amorphous. The degree of crystallinity can be simply determined by powder X-ray diffraction (powder XRD) of the pesticide compound, by optical microscopy (due to birefringence of the crystalline phase), in most cases also from DSC analysis (DSC=differential scanning calorimetry), and in some cases by IR spectrometry.

“Amorphous” in terms of the present invention means that the pesticide compound, which is present in the aqueous emulsion, is essentially not crystalline, i.e., it contains less than 10% by weight, based on the total amount of the pesticide compound, or no traceable amounts of crystalline material. Amorphous forms include liquids forms, i.e., melt and supercooled melt, solution in water miscible solvent, and solid amorphous forms.

In one embodiment, the amorphous organic pesticide has a relatively low melting point. In one embodiment, the amorphous organic pesticide has a melting point of about 55° C., about 60° C., about 65° C., about 70° C., about 75° C., about 80° C., about 85° C., about 90° C., about 95° C. or about 100° C., and any range constructed therefrom, such as for instance from about 55° C. to about 100° C., or from about 65° C. to about 90° C.

In one embodiment, the amorphous organic pesticide has a relatively low solubility in water. In one embodiment, the amorphous organic pesticide has a solubility in water of 0.001 mg/L or less, 0.01 mg/L or less, about 0.1 mg/L, about 0.2 mg/L, about 0.5 mg/L, about 1 mg/L, about 5 mg/L about 10 mg/L, about 25 mg/L about 50 mg/L about 75 mg/L or about 100 mg/L at 25° C., and any range constructed therefrom, such as for instance from about 0.001 mg/L to about 100 mg/L or from about 0.01 mg/L to about 100 mg/L.

In one embodiment, the amorphous organic pesticide is in a form selected from a melt, a supercooled melt, a solid amorphous form, a liquid, a solution comprising an active ingredient and a water miscible solvent, and combinations thereof. In one embodiment, the amorphous organic pesticide is in a form selected from a melt, a supercooled melt, a liquid, a solution comprising an active ingredient and a water miscible solvent, and combinations thereof. In one embodiment, the amorphous organic pesticide is in a form selected from a melt and a supercooled melt. In embodiments comprising two or more amorphous organic pesticides, each such pesticide may be independently selected from a melt, a supercooled melt, a solid amorphous form, a liquid, a solution comprising an active ingredient and a water miscible solvent. For instance, one amorphous organic pesticide may be in the form of a melt and one amorphous organic pesticide may be in solid amorphous form.

In one embodiment, the amorphous organic pesticide is selected from insecticides (such as an insecticide included among a listing of insecticides disclosed elsewhere herein), fungicides (such as a fungicide included among a listing of fungicides disclosed elsewhere herein), herbicides (such as an herbicide included among a listing of herbicides disclosed elsewhere herein), and combinations thereof.

In one embodiment, the amorphous organic pesticide is an insecticide selected from indoxacarb, bifenthrin, gamma-cyhalothrin, and combinations thereof.

In one embodiment, the amorphous organic pesticide is a fungicide selected from difenoconazole, pyraclostrobin, picoxystrobin, and combinations thereof.

In one embodiment, the amorphous organic pesticide is an herbicide selected from beflubutamid, s-beflubutamid, rimisoxamid, bixlozone isoflex, napropamide, aclonifen, and combinations thereof.

In one embodiment, the crystalline organic pesticide has a melting point of about 55° C., about 60° C., about 65° C., about 70° C., about 75° C., about 80° C., about 85° C., about 90° C., about 95° C. or about 100° C., and any range constructed therefrom, such as for instance from about 55° C. to about 100° C. or from about 65° C. to about 90° C.

In one embodiment, the crystalline organic pesticide a relatively low solubility in water. In one embodiment, the amorphous organic pesticide has a solubility in water of 0.001 mg/L or less, 0.01 mg/L or less, about 0.1 mg/L, about 0.2 mg/L, about 0.5 mg/L, about 1 mg/L, about 5 mg/L about 10 mg/L, about 25 mg/L about 50 mg/L about 75 mg/L or about 100 mg/L at 25° C., and any range constructed therefrom, such as for instance from about 0.001 mg/L to about 100 mg/L or from about 0.01 mg/L to about 100 mg/L.

In one embodiment, the crystalline organic pesticide is selected from insecticides (such as an insecticide included among a listing of insecticides disclosed elsewhere herein), fungicides (such as a fungicide included among a listing of fungicides disclosed elsewhere herein), herbicides (such as an herbicide included among a listing of herbicides disclosed elsewhere herein), and combinations thereof.

In one embodiment, the crystalline organic pesticide is an insecticide. In one embodiment, the insecticide is selected from indoxacarb, bifenthrin, gamma-cyhalothrin, and combinations thereof.

In some crystallization embodiments, the amorphous and crystalline organic pesticide may be the same pesticide.

In some crystallization embodiments, the at least one amorphous organic pesticide comprises two or more organic pesticide species, each independently in the form of: (i) a melt, a supercooled melt, a solid amorphous form, a liquid, or a solution comprising an active ingredient and a water miscible solvent, and combinations thereof; (ii) a melt, a supercooled melt, a liquid, or a solution comprising an active ingredient and a water miscible solvent; or (iii) a melt. In embodiments comprising two amorphous organic pesticides, the following combinations are within the scope of the present disclosure: (i) two insecticide species; (ii) two fungicide species; (iii) two herbicide species; (iv) an insecticide species and a fungicide species; (v) an insecticide species and an herbicide species; and (vi) a fungicide species an herbicide species. In embodiments comprising three amorphous organic pesticides, the following non-limited combinations are among those within the scope of the present disclosure: (i) three insecticide species; (ii) three fungicide species; (iii) three herbicide species; (iv) an insecticide species, a fungicide species, and an herbicide species; (v) two insecticide species and an herbicide species; (vi) two insecticide species and a fungicide species, (vii) an insecticide species and two fungicide species; (vii) an insecticide species and two herbicide species; (viii) two herbicide species and a fungicide species; (viii) two fungicide species and an herbicide species. One non-limiting example of a combination of two organic pesticide species is indoxacarb and rynaxypyr.

In some crystallization embodiments, the at least one crystalline organic pesticide comprises two or more organic pesticide species. In embodiments comprising two crystalline organic species, the combinations of insecticides, fungicides, and herbicides recited above for amorphous organic pesticides are within the scope of the present disclosure. Similarly, in embodiments comprising three crystalline organic species, the combinations of insecticides, fungicides, and herbicides recited above for amorphous organic pesticides are within the scope of the present disclosure.

In some crystallization embodiments, the at least one amorphous organic pesticide comprises two or more organic pesticide species and the at least one crystalline organic pesticide comprises two or more organic pesticide species. Each of the two or more amorphous organic pesticide species are independently selected from insecticides, fungicides, and herbicides as described above, and each of the two or more crystalline organic pesticide species are independently selected from insecticides, fungicides, and herbicides as described above.

In some aspects, formulation additives (also termed adjuvants) may be used. In some aspects, the one or more adjuvants are formulation aids. In some aspects, the adjuvant is selected from additional water, dispersants, surfactants, biocides, antifoamers, anti-freeze agents, rheology modifiers (viscosity-modifying agents), wetting agents, non-aqueous solvents, and combinations thereof. In one embodiment, the formulation additive is selected from additional water, dispersants, anti-freeze agents, viscosity-modifying agents, antifoams, bactericides, surfactants, and combinations thereof.

In one embodiment, the compositions and formulations of the present disclosure may further comprise a dispersant. A dispersant can assist in dispersion of active ingredients in the formulation and prevent agglomeration after dispersal in water. The dispersant can be chosen from any dispersant known in the art.

In some aspects, the dispersant is selected from ethoxylated aliphatic alcohol phosphate esters, including Dextrol OC-180 (a phosphate ester salt of ethoxylate alcohol, 39-43% alcohols, 4-6% ethoxylated), Dextrol OC-70, Dextrol OC-50, Dextrol OC-15, Stepfac 8181K, Stepfac 8181 PT3K, Surfom SC8216, Soprophor 3D33 (tristyrylphenol ethoxylate phosphate ester-acid form), Surfom 1323 SC, Stepfac TSP-PE, and a naphthalene sulfonate derivative or a lignosulfonate derivative. In one aspect, the dispersant is Dextrol OC-180, Stepfac 8181K, Stepfac 8181 PT3K, Surfom SC8216, Soprophor 3D33, or Surfom 1323 SC. In one aspect, the dispersant is Dextrol OC-180 or Soprophor 3D33.

In some aspects, the dispersant may comprise at least one polymeric surfactant. Polymeric surfactants fall into several categories including, but not limited to, block copolymers, random copolymers, graft copolymer and star polymers. Polymeric surfactants can be nonionic or anionic. Non-limiting examples of block copolymers include Atlas™ G-5000 and Atlas™ G-5002L (butyl block copolymers). Non-limiting examples of a graft copolymer are methacrylic acid-polyethylene oxide copolymers such as Atlox® 4913 (an acrylic copolymer solution containing propylene glycol, acrylic copolymer, water and methylethyl ketone, 33% active, HLB=12) and STEP-FLOW® 4000. A non-limiting example of a nonionic polymer is Break Thru® DA 647. A non-limiting example of an anionic polymer is modified styrene (meth)acrylic copolymer (e.g. Metasperse TM550s) or salts of lignonsulfonates (e.g. Reax 88B or Borresperse NA).

In one embodiment, the dispersant is present in an amount of about 0.1 wt. %, about 0.5 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, or about 15 wt. %, and any range constructed therefrom, such as for instance, from about 0.1 wt. % to about 15 wt. % from about 1 wt. % to about 10 wt. %, from about 0.5 wt. % to about 5 wt. %, or from about 0.5 wt. % to about 3 wt. %.

In one embodiment, the compositions and formulations of the present disclosure may further comprise a wetting agent. A wetting agent can aid in the milling process. In one embodiment, the wetting agent is selected from nonionic surfactants, anionic surfactants, cationic surfactants, zwitterionic surfactants, and combinations thereof. In one embodiment, the wetting agent is an alkyl polyglycoside, non-limiting examples of which include Agnique PG 9116, Agnique PG 8107, Agnique PG 8105, and alkyl ethoxylates.

In one embodiment, the wetting agent is present in an amount in amount of about 0.01%, about 0.1%, about 1%, about 2%, about 3%, about 4%, about 5%, about 10%, about 15%, about 20%, about 25%, about 30%, or about 35%, and any range constructed therefrom, such as for instance, from about 0.01 wt. % to about 35 wt. %, from about 0.01 wt. % to about 25 wt. %, from about 0.01 wt. % to about 20 wt. %, from about 0.01 wt. % to about 15 wt. %, from about 0.01 wt. % to about 5 wt. %, from about 0.1 wt. % to about 5 wt. %, from about 0.1 wt. % to about 2 wt. %, or from about 0.1 wt. % to about 1 wt. %.

Non-limiting examples of nonionic surfactants include alkoxylates, fatty alcohol alkoxylates, siloxanes/silicones, alkylphenol alkoxylates, fatty acid alkoxylates, alkoxylated amines, alkoxylated fatty acid amides, terminally blocked alkoxylates, fatty acid esters of polyhydroxy compounds, fatty acid esters of glycerol, fatty acid esters of sorbitol, fatty acid esters of sucrose, alkylpolyglucosides, amine oxide, and combinations thereof. Alkoxy groups may suitably be ethoxy, propoxy, or a combination of ethoxy and propoxy groups in random or block configuration.

In more detail, non-limiting examples of nonionic surfactants include: alcohol alkoxylates (such as alcohol alkoxylates based on natural and synthetic alcohols (which may be branched or linear) and prepared from the alcohols and ethylene oxide, propylene oxide, butylene oxide or mixtures thereof); amine ethoxylates, alkanolamides and ethoxylated alkanolamides; alkoxylated triglycerides (such as ethoxylated soybean, castor and rapeseed oils); alkylphenol alkoxylates (e.g., octyl-(such as the Triton® X series), nonyl-(such as the Tergitol® HP series), dinonyl-, or dodecyl-)); ethoxylated fatty acids; ethoxylated fatty esters and oils (such as Break Thru® SP 133); ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers (such as block polymers prepared from ethylene oxide or propylene oxide and reverse block polymers where the terminal blocks are prepared from propylene oxide; ethoxylated fatty acids), alkyd PEG (polyethylene glycol) resins, alkyd type copolyesters, graft or comb polymers, and star polymers; polyethylene glycols (PEG); polyethylene glycol fatty acid esters; silicone-based surfactants; sugar-derivatives such as sucrose esters, alkyl polyglycosides and alkyl polysaccharides; and combinations thereof. In one embodiment, the nonionic surfactant is Agnique PG 9116.

In some aspects, the nonionic surfactant component comprises at least one nonionic surfactant selected from sorbitan fatty acid esters, polyethoxylated sorbitan fatty acid esters, sorbitol ethoxylate esters and combinations thereof. Non-limiting examples of sorbitan fatty acid esters include sorbitan monolaurates (e.g., Span™ 20), sorbitan monopalmitates (e.g., Span™ 40), sorbitan monostearates (e.g., Span™ 60), sorbitan tristearates (e.g., Span™ 65), sorbitan monoolcates (e.g., Span™ 80), sorbitan triolcates (e.g., Span™ 85), and combinations thereof. Non-limiting examples of polyethoxylated sorbitan fatty acid esters include Tween® 20, Tween® 21, Tween® 40, Tween® 60, Tween® 80, and Surfonic® L24-4. Non-limiting examples of sorbitol ethoxylate esters that may be suitable for the biopesticides described herein include polyoxyethylene sorbitol oleates (e.g., Arlatone® TV), polyoxyethylene sorbitol hexaoleates (e.g., Cirrasol® G-1086), polyoxyethylene sorbitol hexaolcates (e.g., Cirrasol® G-1096), polyoxyethylene oleate-laurates (e.g., Atlox 1045AR®), and combinations thereof. Polyethoxylated sorbitan fatty acid esters and sorbitol ethoxylate esters having a degree of ethoxylation of 20, 30, 40, 50, 60, 70 or 80 are generally suitable.

In some aspects, the nonionic surfactant component may comprise at least one organosilicone surfactant. Non-limiting examples of organosilicone surfactants within the scope of the present disclosure include: polyether siloxanes (e.g., Break Thru® OE441); polyether trisiloxanes (e.g., Break Thru® S240, Break Thru® S233); polyoxyethylene dimethylsiloxanes (e.g., Dyne-Amic® (a mixture with methylated seed oil)); polyoxyethylene methylpolysiloxanes (e.g., KF-640 manufactured by Shin-Etsu Chemical Co., Ltd.); polyalkylene oxide-modified polymethylsiloxane (e.g., Kinetic manufactured by Helena Chemical); polyoxyethylene propylheptamethyltrisiloxanes (e.g., Masil® SF19); polyether-modified polysiloxanes (e.g., Quark (a mixture with an alkyl phenol ethoxylate)); hydroxypropyl heptamethyltrisiloxanes (e.g., Silflow® (a mixture with ethoxylated acetate, polyethylene glycol monoallyl ether acetate and polyethylene glycol diacetate); polyalkylene oxide-modified heptamethyltrisiloxanes (e.g., Silwet® L77); polyether/polymethylsiloxane copolymers (e.g., Syl-Coat®); polyoxyethylene-modified polydimethylsiloxanes (e.g., Xiameter®); polyoxyalkylene oxypropylheptamethyltrisiloxanes; siloxane/polyalkylene oxide copolymers (e.g., Vestis™ (a mixture with polyalkylene oxide)). In some aspects, the nonionic surfactant the organosilicone surfactant is a polyether trisiloxane such as, for instance, Break Thru® S240 (a mixture of a polyether trisiloxane and an alcohol ethoxylate (CAS 9043-30-5)), Break Thru® S321, Break Thru® S200, Break Thru® OE 441, Break Thru® S278, Break Thru® S243, Break Thru® S233, Silwet® L-77, Silwet® 408, Silwet® HS 429, Silwet® HS 312, Silwet® Y-12808, Silwet® L-7607, Silwet® L-7602, Silwet® L-7210, Silwet® L-7002, Silwet® L-720, and Silwet® L-7200, Sylgard® 309, and Silibase® 2848, and combinations thereof. In some aspects, the organosilicone surfactant is Break Thru® S240. In some aspects, the organosilicone surfactant is Silwet® HS 312.

In some aspects, the nonionic surfactant component may comprise at least one alcohol alkoxylate surfactant, at least one alkylphenol alkoxylate surfactant, at least seed oil alkoxylate surfactant (e.g., Ecosurf® SA-4, Ecosurf® SA-7, Ecosurf® SA-9, and Ecosurf® SA-15), at least one alkylamine alkoxylate surfactant, at least one tallow amine alkoxylate surfactant, at last one fatty acid alkoxylate surfactant, and combinations thereof. In some aspects, the alkoxylates may be end capped. Alcohol alkoxylates generally comprise a hydrophobic alkyl chain attached by an ether linkage to a hydrophilic alkoxy chain and have the general formula R—(OC₂₋₄)ₙ—OH. R may be C₆₋₁₈ straight or branched chain alkyl. The alkoxy moiety (OC₂₋₄) may be ethoxy, n-propyl, i-propyl, n-butyl, i-butyl or tert-butyl. In some aspects, the alkoxy moiety may be a block co-polymer of a polymeric ethoxy and polymeric propoxy or polymeric butoxy, and n may suitably be an integer of from 2 to 100. Suitable alcohol alkoxylates include linear alcohol alkoxylates, branched alcohol alkoxylates, secondary alcohol alkoxylates, and mixtures thereof. Non-limiting examples of alcohol alkoxylates include: Plurafac® SL-42 (C₆₋₁₀—(PO)₃(EO)₆); Plurafac® SL-62 (C₆₋₁₀—(PO)₃(EO)₈); Lutensol® XL series of the general structure Guerbet C₁₀—(PO)ₐ(EO)_{b} including without limitation Lutensol® XL-40, Lutensol® XL-50, Lutensol® XL-60, Lutensol® XL-70, Lutensol® XL-79, Lutensol® XL-80, Lutensol® XL-89, Lutensol® XL-90, Lutensol® XL-99, Lutensol® XL-100, and Lutensol® XL-140; Lutensol® XP series of the general structure Guerbet C₁₀-(EO)ₐ, including without limitation Lutensol® XP-40, Lutensol® XP-50, Lutensol® XP-60, Lutensol® XP-70, Lutensol® XP-79, Lutensol® XP-80, Lutensol® XP-89, Lutensol® XP-90, Lutensol® XP-99, Lutensol® XP-100; Lutensol® ON series of the general structure oxo C₁₀-(EO)ₐ, including without limitation Lutensol® ON-30, Lutensol® ON-50, Lutensol® ON-60, Lutensol® ON-70, Lutensol® ON-80, Lutensol® ON-110; Lutensol® AO series of the general structure oxo C_{13/15}-(EO)ₐ, including without limitation Lutensol® AO-3, Lutensol® AO-5, Lutensol® AO-7, Lutensol® AO-79, Lutensol® AO-8, Lutensol® AO-11; Lutensol® TO series of the general structure oxo C₁₃-(EO)ₐ, including without limitation Lutensol® TO-6, Lutensol®) TO-65, Lutensol® TO-7, Lutensol®) TO-79, Lutensol® TO-8, Lutensol® TO-89, Lutensol® TO-10, Lutensol® TO-109, Lutensol® TO-12, Lutensol® TO-129, Lutensol® TO-15, Lutensol® TO-20; Lutensol® TDA series of the general structure oxo C₁₁-C₁₄-C₁₃ rich (EO)ₐ, including without limitation Lutensol® TDA-6, Lutensol® TDA 8, Lutensol® TDA-9, Lutensol® TDA-10; Ecosurf® EH series of the general structure 2-ethyl hexyl (PO)ₘ(EO)ₙ including Ecosurf® EH-3, Ecosurf® EH-6, and Ecosurf® EH-9; Ecosurf® SA series including Ecosurf® SA-4 (C₆₋₁₂—(PO)₃₋₄(EO)₄), Ecosurf® SA-7 (C₆₋₁₂—(PO)₃₋₄(EO)₇, and Ecosurf® SA-9 (C₆₋₁₂—(PO)₃₋₄(EO)₉); Tergitol® 15-S-3, Tergitol® 15-S-5, Tergitol® 15-S-7, Tergitol® 15-S-9, Tergitol® 15-S-12, Tergitol® 15-S-15, Tergitol® 15-S-20, Tergitol® 15-S-30, and Tergitol® 15-S-40; Tergitol® L-61, Tergitol® L-62, Tergitol® L-64, Tergitol® L-81, and Tergitol® L-101; Tergitol® TMN-3, Tergitol® TMN-6, and Tergitol® TMN-10), and combinations thereof. In some aspects, the alcohol alkoxylate is Lutensol® TDA 6. In some aspects, the alcohol alkoxylate is Lutensol® TO 6. In some aspects, the alcohol alkoxylate is Lutensol® TO 8.

In some aspects, the nonionic surfactant component may comprise at least one polymeric surfactant. Polymeric surfactants fall into several categories including, but not limited to, block copolymers, random copolymers, graft copolymer and star polymers. Non-limiting examples of polymer monomeric units include ethylene oxide, propylene oxide, acrylic, styrene, methacrylic, hydroxystearate, and ester (e.g., alkyd). Examples include, without limitation, EO/PO block copolymers, acrylic/styrene copolymers, methacrylic copolymers, poly hydroxystearate derivatives, alkyd PEG resin derivatives, and combinations thereof. Non-limiting examples of block copolymers include Atlas™ G-5000 and Atlas™ G-5002L (butyl block copolymers). Non-limiting examples include methacrylic acid-polyethylene oxide copolymers such as Atlox® 4913 (an acrylic copolymer solution containing propylene glycol, acrylic copolymer, water and methylethyl ketone, 33% active, HLB=12) and STEP-FLOW® 4000. In some aspects, the nonionic surfactant component comprises Atlox® 4913 or STEP-FLOW® 4000. In some aspects, the nonionic surfactant component comprises Atlas™ G-5000. In some aspects, the nonionic surfactant component comprises Atlox® 4913 or STEP-FLOW® 4000, Atlas™ G-5000 and Lutensol® TDA 6.

In one embodiment, the noninonic surfactant is present in an amount in the range of about 0.01 wt. % to about 10 wt. %. In another embodiment, the noninonic surfactant is present in an amount in the range of about 0.1 wt. % to about 5 wt. %. In another embodiment, the noninonic surfactant is present in an amount in the range of about 0.1 wt. % to about 2 wt. %. In another embodiment, the noninonic surfactant is present in an amount in the range of about 0.1 wt. % to about 1 wt. %.

The compositions produced according to the present disclosure may comprise one or more anionic surfactants. Non-limiting examples of anionic surfactants include: alkylaryl sulfonic acids and their salts; carboxylated alcohols; diphenyl sulfonate derivatives; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; salts of sulfates of alkoxylated alcohols; sulfonates of amines and amides such as N,N-alkyltaurates; sulfonates of benzene, cumene, toluene, xylene, and dodecyl and tridecylbenzenes; sulfonates of naphthalene and alkyl naphthalene; sulfonates of fractionated petroleum; sulfosuccinamates; sulfosuccinates and their derivatives such as dialkyl sulfosuccinate salts; and combinations thereof. Non-limiting examples of cationic counterions of the anionic surfactants in salt form may include, but are not limited to, alkali metal, alkaline-earth metal, ammonium, or (C₁₋₆) alkyl ammonium cation.

Non-limiting examples of anionic surfactants within the scope of the present disclosure include: ammonium lauryl sulfate; magnesium lauryl sulfate; sodium 2-ethyl-hexyl sulfate; sodium octyl sulfate; sodium oleyl sulfate; sodium tridecyl sulfate; triethanolamine lauryl sulfate; ammonium nonylphenol ether sulfate; ammonium monoxynol-4-sulfate sulfo succinamates; tetrasodium N-(1,2-dicarboxyethyl)-N-octadecylsulfo-succinamate; diamyl ester of sodium sulfosuccinic acid; dihexyl ester of sodium sulfosuccinic acid; dioctyl esters of sodium sulfosuccinic acid; dihexyl ester of sodium sulfosuccinic acid; dioctyl esters of sodium sulfosuccinic acid (Acrosol OT 75 PG); calcium naphthalene sulfonates (DAXAD® 19LCAD); sodium methyl oleyl taurate (Geropon® T-77); sodium dodecylbenzene sulfonate; sodium dodecyl sulfate; N-oleyl N-methyl taurate; 1,4-dioctoxy-1,4-dioxo-butane-2-sulfonic acid; sodium lauryl sulphate; sodium lauryl ether sulfate (Steol CS-370); calcium dodecylbenzenesulfonate (Rhodacal® 60 BE and 70 B); isopropyl amine dodecylbenzenesulfonate (Bio-Soft® N-411); sodium diisopropyl naphthalenesulfonate (Morwet® IP); and combinations thereof. In one aspect, the anionic surfactant is Aerosol OT 75 PG. In one aspect, the anionic surfactant comprises a blend of sodium decyl sulfate and sodium dodecyl sulfate. In one such aspect, the anionic surfactant is Polystep® B25U.

In some aspects of the present disclosure, the surfactant component can comprise a mixture of at least one nonionic surfactant and at least one anionic surfactant.

In one embodiment, the anionic surfactant is present in an amount in the range of from about 0.01 wt. % to about 15 wt. %. In another embodiment, the noninonic surfactant is present in an amount in the range of from about 0.1 wt. % to about 2 wt. %. In another embodiment, the noninonic surfactant is present in an amount in the range of about 0.1 wt. % to about 1 wt. %.

In some aspects of the disclosure, the surfactant component may optionally comprise at least one cationic surfactant. Non-limiting examples of cationic surfactants include: amides and ethoxylated amides; amines (such as N-alkyl propanediamines, tripropylenetriamines and dipropylenetetramines); ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; amine oxides such as alkyldimethylamine oxides and bis-(2-hydroxyethyl)-alkylamine oxides; and combinations thereof.

In some aspects of the disclosure, the surfactant component may optionally comprise at least one zwitterionic (ampholytic) surfactant. Non-limiting examples of Zwitterionic (amphoteric) surfactants include betaines, N-alkyl glycines, N-alkyl propionic acids, N-alkylaminobutyric acids, N-alkyliminodipropionic acids, N-hydroxyethyl-N-alkylamidopropyl glycines, N-alkyl taurines, N-alkyl sarcosines, 2-alkylaminopropionic acids, alkylaminoacetic acids containing a C₈₋₁₈ alkyl group, and combinations thereof.

In aspects where the surfactant component comprises one or more nonionic surfactant and one or more anionic surfactants, the weight ratio of total nonionic surfactant to total anionic surfactant is suitably about 5:1, about 4:1, about 3.5:1, about 3.25:1, about 3:1, about 2.75:1, about 2.5:1, about 2.25:1, about 2:1, about 1.75:1, about 1.5:1, about 1.25:1, or about 1:1, and ranges constructed therefrom, such as from about 5:1 to about 1:1, from about 3.5:1 to about 1:1, from about 3.5:1 to about 1.5:1, from about 3.25:1 to about 1.75:1, from about 3:1 to about 1.75:1, from about 2.75:1 to about 1.75:1, or from about 2.75:1 to about 1.5:1. In such aspects, the total nonionic surfactant content in the concentrate compositions is suitably about 1 wt. %, about 2 wt. %, about 5 wt. %, about 10 wt. %, about 12.5 wt. %, about 15 wt. %, about 17.5 wt. %, about 20 wt. %, about 22.5 wt. %, about 25 wt. %, about 30 wt. %, or about 35 wt. %, and ranges constructed therefrom, such as from about 1 wt. % to about 35 wt. %, from about 1 wt. % to about 10 wt. %, from about 2 wt. % to about 10 wt. %, from about 2 wt. % to about 35 wt. %, from about 5 wt. % to about 30 wt. %, from about 10 wt. % to about 25 wt. %, from about 12.5 wt. % to about 20 wt. %, or from about 12.5 wt. % to about 17.5 wt. %. In such aspects, the total anionic surfactant content in the concentrate compositions is suitably about 0.1 wt. %, about 0.2 wt. %, about 0.3 wt. %, about 0.4 wt. %, about 0.5 wt. %, about 0.75 wt. %, about 1 wt. %, about 1.5 wt. %, about 2 wt. %, about 2.5 wt. %, about 5 wt. %, about 6 wt. %, about 7 wt. %, about 8 wt. %, about 9 wt. %, about 10 wt. %, about 12.5 wt. %, about 15 wt. %, about 20 wt. %, or about 25 wt. %, and ranges constructed therefrom, such as from about 2 wt. % to about 25 wt. %, from about 2.5 wt. % to about 20 wt. %, from about 2.5 wt. % to about 15 wt. %, from about 2.5 wt. % to about 10 wt. %, or from about 5 wt. % to about 10 wt. %.

In one embodiment, the compositions and formulations of the present disclosure may further comprise an antifreeze agent. An antifreeze agent can prevent the formulation from freezing. In one embodiment, the antifreeze agent is selected from propylene glycol, glycerol, urea, inorganic salts selected from ammonium, sodium, potassium, lithium salts of sulfate, nitrate, chloride, citrate, phosphate, polyphosphate, acetate, tartrate, and succinate, calcium, magnesium salts of nitrate, chloride, citrate, acetate, tartrate, succinate, and combinations thereof. In some aspects of the present disclosure, the antifreeze agent is propylene glycol. In some aspects of the present disclosure, the antifreeze agent is glycerol. In some aspects of the present disclosure, the antifreeze agent is ammonium sulfate. In some aspects of the present disclosure, the antifreeze agent is a mixture of glycerol and ammonium sulfate.

In one embodiment, the compositions and formulations of the present disclosure may further comprise a biocide. A biocide can prevent bacteria from growing. Suitable biocides include, but are not limited to bactericides such as Legend™ MK (mixture of 5-chloro-2-methyl-3 (2H)-isothiazolone with 2-methyl-3 (2H)-isothiazolone), EDTA (ethylenediaminetetraacetic acid), formaldehyde, benzoic acid, or 1,2-benzisothiazol-3 (2H)-one or its salts, e.g., Proxel® BD or Proxel® GXL (Arch), Acticide LA 1209, Acticide LG, Acticide SPX, Proxel GXL, KathonCG/ICP and KathonCG/ICPII. In one embodiment, the biocide is selected from 2-Bromo-2-nitropropane-1,3-diol, 5-Chloro-2-methyl-2H-isothiazol-3-one, 2-Methyl-2H-isothiazol-3-one, and combinations thereof. In one embodiment, the biocide is Proxel GXL and/or Acticide LG.

In one embodiment, the biocide is present in an amount in the range of about 0.01 wt. % to about 2 wt. %. In another embodiment, the biocide is present in an amount in the range of about 0.01 wt. % to about 1 wt. %. In another embodiment, the biocide is present in an amount in the range of about 0.01 wt. % to about 0.5 wt. %. In another embodiment, the biocide is present in an amount in the range of about 0.01 wt. % to about 0.1 wt. %.

In one embodiment, the compositions and formulations of the present disclosure may further comprise an antifoamer. Antifoamers can prevent foaming during manufacturing and handling of the product. In one embodiment, the antifoamer is selected from silicone-based emulsions. In one embodiment, the antifoam is a poly diemethyl siloxane emulsion such as for instance and without limitation Xiameter AFE-0100, SAG 1572, Agnique DFM 111S, Break Thru AF 9903, Silfoam SRE antifoam emulsion (poly diemethyl siloxane emulsion, 35%). In one embodiment, the antifoamer is Silfoam SRE antifoam or Xiameter AFE-0100.

In one embodiment, the antifoamer is present in an amount in the range of about 0.01 wt. % to about 2 wt. %. In another embodiment, the antifoamer is present in an amount in the range of about 0.01 wt. % to about 1 wt. %. In another embodiment, the antifoamer is present in an amount in the range of about 0.01 wt. % to about 0.5 wt. %.

In one embodiment, the compositions and formulations of the present disclosure may further comprise a rheology modifier. A rheology modifier can prevent settling and sedimentation. In one embodiment, the rheology modifier is a viscosity-modifying agent. In one embodiment, the rheology modifier is selected from hydrated magnesium aluminosilicate, xantham gum, amorphous silica, and combinations thereof. In one aspect, suitable commercially available rheology modifiers include, for example, Van Gel B, Veegum K, Vecgum HS, Veegum R, Vecgum T, Veegum Pure, Acti-gel 208, Rhodopol 23, Kelzan S, Kelzan S plus, Acrosil, AEROSIL® R 202, AEROSIL® R 805, AEROSIL® R 812 S, AEROSIL® R 816, AEROSIL® R 972, AEROSIL® R 974, AEROSIL® 200, AEROSIL® 300, AEROSIL® 380, and Bentonite (e.g Vanatural). In another aspect, suitable viscosity-modifying agents are sodium carboxymethylcellulose, hydroxyethyl cellulose, hydroxypropyl cellulose and hydroxypropylmethyl cellulose. In one embodiment, the rheology modifier is Rhodopol 23 and/or Veegum R.

In one embodiment, the rheology modifier is present in an amount in the range of about 0.01 wt. % to about 5 wt. %. In another embodiment, the rheology modifier is present in an amount in the range of about 0.01 wt. % to about 4 wt. %. In another embodiment, the rheology modifier is present in an amount in the range of about 0.01 wt. % to about 3 wt. %. In another embodiment, the rheology modifier is present in an amount in the range of about 0.01 wt. % to about 2 wt. %. In another embodiment, the rheology modifier is present in an amount in the range of about 0.01 wt. % to about 1 wt. %. In another embodiment, the rheology modifier is present in an amount in the range of about 0.01 wt. % to about 0.5 wt. %. In another embodiment, the rheology modifier is present in an amount in the range of about 0.01 wt. % to about 0.25 wt. %. In another embodiment, the rheology modifier is present in an amount in the range of about 0.01 wt. % to about 0.1 wt. %.

In one embodiment, the crystalline pesticide formulations of the present disclosure further comprises a safener. As used herein, the term “safener” refers to a substance that, when added to a herbicide formulation, eliminates or reduces the phytotoxic effects of the herbicide to certain crops. One of ordinary skill in the art would appreciate that the choice of safener depends, in part, on the crop plant of interest and the particular pesticide or combination of pesticides. Suitable safeners include, for example, furilazole, AD 67 (4-(dichloroacetyl)-1-oxa-4-azaspiro[4,5]decane), benoxacor, cloquintocet-mexyl, BCS (1-bromo-4-[(chloromethyl) sulfonyl]benzene), cyometrinil, cyprosulfamide, dichlormid, dicyclonon, dietholate, fenchlorazole-ethyl, fenclorim, flurazole, fluxofenim, isoxadifen, mefenpyr, mephenate, MG 191 (2-(dichloromethyl)-2-methyl-1,3-dioxolane), methoxyphenone, naphthalic anhydride, oxabetrinil, and combinations thereof. In one embodiment, the safener is cloquintocet-mexyl.

In one embodiment, an aqueous suspension of crystalline organic pesticides may be prepared as follows. A mixture comprising a source of at least one amorphous organic pesticide, water, and at least one formulation additive is formed. At least one crystalline organic pesticide is added to the mixture. The at least one amorphous organic pesticide is then crystallized from the mixture. In some embodiments, the at least one amorphous organic pesticide is in a form selected from a melt, a supercooled melt, a solid amorphous form, a liquid, a solution comprising an active ingredient and a water miscible solvent, and combinations thereof. In some embodiments, the at least one amorphous organic pesticide is in a form selected from a melt, a supercooled melt, a liquid, a solution comprising an active ingredient and a water miscible solvent, and combinations thereof. In some embodiments, a melt of the amorphous pesticide is formed in a first vessel as a temperature as described elsewhere herein, such as from about 55° C. to about 100° C. In a second vessel, a mixture of formulation ingredients comprising water and at least one formulation additive (ingredients) is formed. Formulation additives are described elsewhere herein. In one embodiment, the additive comprises at least one dispersant, at least one surfactant, or a combination thereof. The weight ratio of amorphous organic pesticide to formulation additive, excluding water, is suitably about 1:1, about 1.25:1, about 1.5:1 about 1.75:1, about 2:1, about 2.25:1, about 2.5:1, about 3:1, about 3.5:1, about 4:1, about 4.5:1, or about 5:1, or greater, and any range constructed therefrom, such as from about 1:1 to about 5:1, from about 1.25:1 to about 3:1, or from about 1.5:1 to about 2.5:1. In some aspects, the temperature of the melt of the amorphous pesticide and the temperature of the mixture of formulation ingredients is approximately equal. The melt of the amorphous pesticide and the mixture of formulation ingredients are combined with agitation to form an admixture. In some aspects, the temperature may be maintained around the temperature of the melt for a period of time while agitating, such as about 5 minutes, about 10 minutes, about 15 minutes, about 30 minutes, about one hour, about 2 hours, or longer.

In some embodiments, the admixture of the amorphous pesticide and the mixture of formulation ingredients may be optionally cooled to an intermediate, lower, temperature with agitation prior to addition of at least one crystalline organic pesticide to the admixture. For instance the temperature may be cooled by about 5° C., about 10° C., about 15° C., or about 20° C. In some aspects, the intermediate cooled temperature is a temperature above the supersaturation temperature. The temperature of the cooled admixture may be maintained around the cooled temperature for a period of time while agitating, such as about 5 minutes, about 10 minutes, about 15 minutes, about 30 minutes, about one hour, about 2 hours, or longer. In said embodiment, the cooled admixture of the amorphous pesticide and the mixture of formulation ingredients may be optionally further cooled with agitation prior to addition of at least one crystalline organic pesticide to the admixture. In some aspects, the final intermediate cooled temperature is a temperature at or above the supersaturation temperature. In some optional aspects, the admixture of the amorphous pesticide and the mixture of formulation ingredients may be stepwise, continuously or semi-continuously cooled with agitation to the final temperature over a period of time, such as about 30 minutes, about 1 hour, about 1.5 hours, about 2 hours, about 2.5 hours, about 3 hours, or longer.

In some embodiments, the at least one crystalline organic pesticide is added with agitation to the optionally cooled admixture of the amorphous pesticide and the mixture of formulation ingredients. The resulting admixture is then further cooled to generate a super-saturated solution and induce crystallization of the amorphous pesticide thereby forming a mixture comprising crystalline organic pesticide, water, and the at least one formulation additive. The final temperature may suitably be about 0° C., about 5° C., about 10° C., about 15° C. or about 20° C. Cooling to the final temperature may be done step-wise, semi-continuously, or continuously to the final temperature over a period of time, such as about 1 hour, about 2 hours, about 3 hours, about 4 hours, about 5 hours, about 6 hours, about 7 hours, about 8 hours, or longer.

In another embodiment for preparing an aqueous suspension of crystalline organic pesticides, a mixture comprising a source of at least one crystalline organic pesticide, water, and at least one formulation additive is formed. At least one amorphous organic pesticide is added to the mixture. The at least one amorphous organic pesticide is then crystallized from the mixture. In some embodiments, the at least one amorphous organic pesticide is in a form selected from a melt, a supercooled melt, a solid amorphous form, a liquid, a solution comprising an active ingredient and a water miscible solvent, and combinations thereof. In some embodiments, the at least one amorphous organic pesticide is in a form selected from a melt, a supercooled melt, a liquid, a solution comprising an active ingredient and a water miscible solvent, and combinations thereof. In one such embodiment, a melt of the amorphous pesticide is formed in a first vessel as a temperature as described elsewhere herein, such as from about 55° C. to about 100° C. In a second vessel, a mixture of formulation ingredients comprising water, at least one crystalline organic pesticide, and at least one formulation additive (ingredients) is formed. The formulation additive is suitably selected from additional water, dispersants, anti-freeze agents, viscosity-modifying agents, antifoams, bactericides, surfactants, and combinations thereof. In one embodiment, the additive comprises at least one dispersant, at least one surfactant, or a combination thereof. The weight ratio of amorphous organic pesticide to formulation additive, excluding water, is suitably about 1:1, about 1.25:1, about 1.5:1 about 1.75:1, about 2:1, about 2.25:1, about 2.5:1, about 3:1, about 3.5:1, about 4:1, about 4.5:1, or about 5:1, or greater, and any range constructed therefrom, such as from about 1:1 to about 5:1, from about 1.25:1 to about 3:1, or from about 1.5:1 to about 2.5:1. In some aspects, the temperature of the melt of the amorphous pesticide and the temperature of the mixture of water, crystalline organic pesticide, and at least one formulation additive are approximately equal. The melt of the amorphous pesticide and the aqueous mixture comprising crystalline organic pesticide are combined with agitation to form an admixture. In some aspects, the admixture temperature may be maintained around the temperature of the melt for a period of time while agitating, such as about 5 minutes, about 10 minutes, about 15 minutes, about 30 minutes, about one hour, about 2 hours, or longer.

The admixture may be optionally cooled to an intermediate, lower, temperature with agitation prior to addition of at least one crystalline organic pesticide to the admixture. For instance the temperature may be cooled by about 5° C., about 10° C., about 15° C., or about 20° C. In some aspects, the intermediate cooled temperature is a temperature above the supersaturation temperature. The temperature of the cooled admixture may be maintained around the cooled temperature for a period of time while agitating, such as about 5 minutes, about 10 minutes, about 15 minutes, about 30 minutes, about one hour, about 2 hours, or longer. In some aspects, the final intermediate cooled temperature is a temperature at or above the supersaturation temperature. In some optional aspects, the admixture may be continuously or semi-continuously cooled with agitation to the final intermediate temperature over a period of time, such as about 30 minutes, about 1 hour, about 1.5 hours, about 2 hours, about 2.5 hours, about 3 hours, or longer. The admixture is then further cooled to generate a super-saturated solution and induce crystallization of the amorphous pesticide thereby forming a mixture comprising crystalline organic pesticide, water, and the at least one formulation additive. The final temperature may suitably be about 0° C., about 5° C., about 10° C., about 15° C. or about 20° C. Cooling to the final temperature may be done step-wise, semi-continuously, or continuously to the final temperature over a period of time, such as about 1 hour, about 2 hours, about 3 hours, about 4 hours, about 5 hours, about 6 hours, about 7 hours, about 8 hours, or longer.

In some crystallization embodiments, at least a portion of the crystallized pesticide composition may be in the form of agglomerates that are not generally freely flowable. In such embodiments, agglomerated crystallized pesticide may be suitably processed by methods known in the art to form a flowable suspension. For instance the composition may be homogenized such as by impacting the crystalline material to break apart agglomerates. In one such embodiment, the crystalline agglomerates may be homogenized using a high shear mixer in order to form a flowable suspension.

In one embodiment, the crystalline pesticide formulations may be milled to desired particle sizes. In one embodiment, the suspension concentrate formulations may be milled to an average D (90) particle size of about 0.5 μm, about 1 μm, about 2 μm, about 3 μm, about 4 μm, about 5 μm, about 10 μm, about 15, or about 20 μm., and any range constructed therefrom, such as for instance from about 0.5 μm to about 20 μm, from about 0.5 μm to about 10 μm, from about 0.5 μm to about 5 μm, or from about 0.5 μm to about 3 μm.

In one embodiment, the crystalline pesticide formulations are optionally filtered and dried before milling. In one embodiment, crystalline pesticide formulations are filtered before milling. In one embodiment, the crystalline pesticide formulations are dried before milling.

In one embodiment, the process step of milling the mixture occurs with a device selected from attritor mills, bead mills, colloid mills, rotor-stators, jet mills, air classifying mills, ring mills, hammer mills, pin mills, puck mills, and combinations thereof. In another embodiment, the process step of milling the mixture occurs with a mill selected from ring mills, bead mills, attritor mills, jet mills, air classifying mills, and combinations thereof.

In one embodiment, the crystalline pesticide formulation is formed in a mix vessel before being transferred to a milling device. In one embodiment, the crystalline pesticide formulation formed in a milling device. In one embodiment, the crystalline pesticide formulation transferred to a holding tank after milling in a milling device. In one embodiment, the crystalline pesticide formulation is prepared in a continuous process.

In one embodiment, one or more formulation additives may be combined with the crystalline pesticide formulations of the present disclosure, including milled crystalline pesticide formulation. The formulation additives are described elsewhere herein and are selected from additional water, dispersants, anti-freeze agents, viscosity-modifying agents (e.g., thickeners), antifoams, bactericides, surfactants, and combinations thereof.

In any of the embodiments of the present disclosure, the crystalline pesticide formulation is a suspension concentrate. The total pesticide content of suspension concentrates of the present disclosure on an active ingredient basis is about 10 wt. %, about 15 wt. %, about 20 wt. %, about 25 wt. %, about 30 wt. %, about 35 wt. %, about 40 wt. %, or about 45 wt. %, and any range constructed therefrom, such as from about 10 wt. % to about 45 wt. %, from about 20 wt. % to about 45 wt. %, or from about 30 wt. % to about 45 wt. %. Alternatively, the total pesticide content of suspension concentrates of the present disclosure on an active ingredient basis is about 100 g/L, about 150 g/L, about 200 g/L, about 250 g/L, about 300 g/L, about 350 g/L, about 400 g/L, about 450 g/L, about 500 g/L, about 550 g/L, or about 600 g/L, and any range constructed therefrom, such as from about 200 g/L to about 600 g/L, from about 300 g/L to about 600 g/L.

In some embodiments, the suspension concentrate compositions of the present disclosure are diluted with water and optional additive and co-pesticides to provide spray mixtures that can be used according to the disclosure. The concentration of active compound in the spray mixtures of the disclosure can be varied within a certain range. In general, the concentration of active compound is from about 0.0003 to about 5 percent by weight active ingredient, in one embodiment from about 0.003 to about 3 percent by weight, and in another embodiment from about 0.01 to about 0.06 percent by weight.

To prepare aqueous spray mixtures that are ready for application, the concentrated formulation can be mixed with a quantity of water, with stirring and/or pumping if necessary to uniformly distribute the formulation in the water.

Conventional mixing apparatus and/or spray equipment suitable for the purpose can be employed for the preparation and application of the spray mixtures of the disclosure.

The suspension concentrate compositions and/or aqueous spray mixtures produced according to the present disclosure may optionally include one or more additional pest control agents selected from insecticides, herbicides, biopesticides, nematicides, bactericides, and fungicides. General references for these pest control agents (i.e., insecticides, fungicides, nematicides, acaricides, herbicides and biological agents) include The Pesticide Manual, 13th Edition, C. D. S. Tomlin, Ed., British Crop Protection Council, Farnham, Surrey, U. K., 2003 and The BioPesticide Manual, 2^{nd} Edition, L. G. Copping, Ed., British Crop Protection Council, Farnham, Surrey, U. K., 2001.

Non-limiting examples of additional insecticides include abamectin, acephate, acequinocyl, acetamiprid, acrinathrin, acynonapyr, afidopyropen ([(3S,4R,4aR,6S,6aS,12R,12aS,12bS)-3-[(cyclopropylcarbonyl)oxy]-1,3,4,4a,5,6,6a,12,12a,12b-decahydro-6,12-dihydroxy-4,6a, 12b-trimethyl-11-oxo-9-(3-pyridinyl)-2H, 11H-naphtho[2,1-b]pyrano[3,4-e]pyran-4-yl]methyl cyclopropanecarboxylate), amidoflumet, amitraz, avermectin, azadirachtin, azinphos-methyl, benfuracarb, bensultap, benzpyrimoxan, bifenazate, bistrifluron, borate, broflanilide, buprofezin, cadusafos, carbaryl, carbofuran, cartap, carzol, chlorantraniliprole (Rynaxypyr®) chlorfenapyr, chlorfluazuron, chloroprallethrin, chlorpyrifos, chlorpyrifos-e, chlorpyrifos-methyl, chromafenozide, clofentezin, chloroprallethrin, clothianidin, cycloprothrin, cycloxaprid ((5S,8R)-1-[(6-chloro-3-pyridinyl)methyl]-2,3,5,6,7,8-hexahydro-9-nitro-5,8-Epoxy-1H-imidazol 1,2-alazepine), cyenopyrafen, cyflumetofen, cyfluthrin, beta-cyfluthrin, cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy) phenoxy]-4-quinolinyl methyl carbonate), flonicamid, fluazaindolizine, flucythrinate, flufenerim, flufenoxuron, flufenoxystrobin (methyl (αE)-2-[[2-chloro-4-(trifluoromethyl) phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl) sulfinyl]-1H-pyrazole-3-carbonitrile), flupyradifurone (4-[[(6-chloro-3-pyridinyl)methyl] (2,2-difluoroethyl)amino]-2(5H)-furanone), flupyrimin, fluvalinate, tau-fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, insecticidal soaps, isofenphos, isocycloscram, kappa-tefluthrin, lambda-cyhalothrin, lufenuron, malathion, meperfluthrin ([2,3,5,6-tetrafluoro-4-(methoxymethyl)phenyl]methyl (1R,3S)-3-(2,2-dichlorocthenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, N-[1,1-dimethyl-2-(methylthio)ethyl]-7-fluoro-2-(3-pyridinyl)-2H-indazole-4-carboxamide, N-[1,1-dimethyl-2-(methylsulfinyl)ethyl]-7-fluoro-2-(3-pyridinyl)-2H-indazole-4-carboxamide, N-[1,1-dimethyl-2-(methylsulfonyl)ethyl]-7-fluoro-2-(3-pyridinyl)-2H-indazole-4-carboxamide, N-(1-methylcyclopropyl)-2-(3-pyridinyl)-2H-indazole-4-carboxamide, N-[1-(difluoromethyl)cyclopropyl]-2-(3-pyridinyl)-2H-indazole-4-carboxamide, oxamyl, oxazosulfyl, parathion, parathion-methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ⁴-sulfanylidene]cyanamide), tebufenozide, tebufenpyrad, teflubenzuron, tefluthrin, kappa-tefluthrin, terbufos, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi, and combinations thereof.

Non-limiting examples of additional fungicides include fungicides such as acibenzolar-S-methyl, aldimorph, ametoctradin, aminopyrifen, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, carboxin, carpropamid, captafol, captan, carbendazim, chloroneb, chlorothalonil, chlozolinate, copper hydroxide, copper oxychloride, copper sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethirimol, dimethomorph, dimoxystrobin, diniconazole (including diniconazole-M), dinocap, dipymetitrone, dithianon, dithiolanes, dodemorph, dodine, econazole, ctaconazole, edifenphos, enoxastrobin (also known as enestroburin), epoxiconazole, ethaboxam, ethirimol, etridiazole, famoxadone, fenamidone, fenaminstrobin, fenarimol, fenbuconazole, fenfuram, fenhexamide, fenoxanil, fenpiclonil, fenpicoxamid, fenpropidin, fenpropimorph, fenpyrazamine, fentin acetate, fentin hydroxide, ferbam, ferimzone, flometoquin, florylpicoxamid, fluopimomide, fluazinam, fludioxonil, flufenoxystrobin, fluindapyr, flumorph, fluopicolide, fluopyram, fluoxapiprolin, fluoxastrobin, fluquinconazole, flusilazole, flusulfamide, flutianil, flutolanil, flutriafol, fluxapyroxad, folpet, fthalide (also known as phthalide), fuberidazole, furalaxyl, furametpyr, hexaconazole, hymexazole, guazatine, imazalil, imibenconazole, iminoctadine albesilate, iminoctadine triacetate, inpyrfluxam, iodicarb, ipconazole, ipfentrifluconazole, ipflufenoquin, isofetamid, iprobenfos, iprodione, iprovalicarb, isoflucypram, isoprothiolane, isopyrazam, isotianil, kasugamycin, kresoxim-methyl, lancotrione, mancozeb, mandipropamid, mandestrobin, maneb, mapanipyrin, mefentrifluconazole, mepronil, meptyldinocap, metalaxyl (including metalaxyl-M/mefenoxam), metconazole, methasulfocarb, metiram, metominostrobin, metyltetraprole, metrafenone, myclobutanil, naftitine, neo-asozin (ferric methancarsonate), nuarimol, octhilinone, ofurace, orysastrobin, oxadixyl, oxathiapiprolin, oxolinic acid, oxpoconazole, oxycarboxin, oxytetracycline, penconazole, pencycuron, penflufen, penthiopyrad, perfurazoate, phosphorous acid (including salts thereof, e.g., fosetyl-aluminum), picoxystrobin, piperalin, polyoxin, probenazole, prochloraz, procymidone, propamocarb, propiconazole, propineb, proquinazid, prothiocarb, prothioconazole, pydiflumetofen (Adepidyn®), pyraclostrobin, pyrametostrobin, pyrapropoyne, pyraoxystrobin, pyraziflumid, pyrazophos, pyribencarb, pyributacarb, pyridachlometyl, pyrifenox, pyriofenone, perisoxazole, pyrimethanil, pyrifenox, pyrrolnitrin, pyroquilon, quinconazole, quinmethionate, quinofumelin, quinoxyfen, quintozene, silthiofam, sedaxane, simeconazole, spiroxamine, streptomycin, sulfur, tebuconazole, tebufloquin, teclofthalam, tecloftalam, tecnazene, terbinafine, tetraconazole, thiabendazole, thifluzamide, thiophanate, thiophanate-methyl, thiram, tiadinil, tolclofos-methyl, tolprocarb, tolyfluanid, triadimefon, triadimenol, triarimol, triazoxide, tribasic copper sulfate, triclopyricarb, tridemorph, trifloxystrobin, triflumizole, trimoprhamide tricyclazole, trifloxystrobin, triforine, triticonazole, uniconazole, validamycin, valifenalate (also known as valifenal), vinclozolin, zineb, ziram, zoxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, and combinations thereof.

Non-limiting examples of additional herbicides include: cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofop-butyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; arylaminopropionic acids, such as flamprop-methyl or flamprop-isopropyl; acetolactate synthase inhibitors (ALS), such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium. KIH-6127 or pyribenzoxym; sulfonamides, such as florasulam, flumetsulam or metosulam; sulfonylureas, such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron-methyl, prosulfuron, pyrazosulfuron-ethyl, rimsulfuron, sulfomcturon-methyl, thifensulfuron-methyl, triasulfuron, tribenuron-methyl, triflusulfuron-methyl, tritosulfuron, sulfosulfuron, foramsulfuron or iodosulfuron; amides, such as allidochlor (CDAA), benzoylprop-ethyl, bromobutide, chiorthiamid, diphenamid, ctobenzanidibenzchlomet), fluthiamide, fosamin or monalide; auxin herbicides, such as pyridinecarboxylic acids, such as clopyralid or picloram; 2,4-D or benazolin; auxin transport inhibitors, such as naptalame or diflufenzopyr; carotenoid biosynthesis inhibitors, such as benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, norflurazon or amitrol; enolpyruvylshikimate-3-phosphate synthase inhibitors (EPSPS), such as glyphosate or sulfosate; glutamine synthetase inhibitors, such as bilanafos (bialaphos) or glufosinate-ammonium; lipid biosynthesis inhibitors, such as anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC, esprocarb, molinate, pebulate, prosulfocarb, thiobencarb (benthiocarb), tri-allate or vemolate; or benfuresate or perfluidone; mitosis inhibitors, such as asulam, carbetamid, chlorpropham, orbencarb, pronamid (propyzamid), propham or tiocarbazil; dinitroanilines, such as benefin, butralin, dinitramin, cthalfluralin, fluchloralin, oryzalin, pendimethalin, prodiamine or trifluralin; pyridines, such as dithiopyr or thiazopyr; butamifos, chlorthal-dimethyl (DCPA) maleic hydrazide; protoporphyrinogen IX oxidase inhibitors, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; pyrazoles, such as ET-751.JV 485 or nipyraclofen; photosynthesis inhibitors, such as propanil, pyridate or pyridafol; benzothiadiazinones, such as bentazone; dinitrophenols, suxch as bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as bromoxynil or ioxynil; chloridazon; triazines, such as ametryn, atrazine, cyanazine, desmein, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; synergists, such as tridiphane; CIS cell wall synthesis inhibitors, such as isoxaben or dichlobenil; dichloropropionic acids, such as dalapon; dihydrobenzofurans, such as ethofumesate; phenylacetic acids, such as chlorfenac (fenac); or aziprotryn, barban, beflubutamid, s-beflubutamid, bensulide, benzthiazuron, benzofluor, bixlozone, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, isoflex, karbutilate, mefluidide, monuron, napropamide, napropamide-M, napropanilide, nitralin, oxaciclomefone, phenisopham, piperophos, procyazine, profluralin, pyributicarb, rimisoxamid, secbumeton, sulfallate (CDEC), terbucarb, triaziflam, triazofenamid or trimeturon; their environmentally compatible salts; and combinations thereof. In some embodiments, the herbicide is selected from the group consisting of: beflubutamid, s-beflubutamid, rimisoxamid, bixlozone, isoflex, napropamide, aclonifen, and combinations thereof.

Non-limiting examples of additional nematocides include fluopyram, spirotetramat, thiodicarb, fosthiazate, abamectin, iprodione, fluensulfone, dimethyl disulfide, tioxazafen, 1,3-dichloropropene (1,3-D), metam (sodium and potassium), dazomet, chloropicrin, fenamiphos, ethoprophos, cadusaphos, terbufos, imicyafos, oxamyl, carbofuran, tioxazafen, Bacillus firmus, Pasteuria nishizawae, and combinations thereof. A non-limiting example of a bactericide is streptomycin. Non-limiting examples of additional acaricides include amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, and combinations thereof.

One or more additional additives may optionally be combined with aqueous spray mixtures produced according to the present disclosure. Examples of such additives include, for instance and without limitation, safeners (as described elsewhere herein), dispersants (as described elsewhere herein), surfactants (as described elsewhere herein), oils (e.g., crop oil concentrate and/or methylated seed oil), nitrogen-based fertilizers (e.g., ammonium sulfate and/or urea ammonium nitrate), defoamers, suspension agents, buffers, conditioning or water-softening agents, deposition agents (stickers), drift control agents, and colorants.

### Phytophagous Insects

Phytophagous insects refers to invertebrate pests causing injury to plants by feeding upon them, such as by eating foliage, stem, leaf, fruit or seed tissue or by sucking the vascular juices of plants. Leaf feeders may be external (exophytic) or they may mine the tissues, sometimes even specializing on a particular cell type. There are phytophagous insect species in the majority of insect orders, including Hemiptera, Thysanoptera, Orthoptera, Lepidoptera, Coleoptera, Heteroptera, Hymenoptera, and Diptera.

Examples of agronomic or nonagronomic invertebrate pests include eggs, larvac and adults of the order Lepidoptera, such as armyworms, cutworms, loopers, and heliothines in the family Noctuidae (e.g., pink stem borer (Sesamia inferens Walker), corn stalk borer (Sesamia nonagrioides Lefebvre), southern armyworm (Spodoptera eridania Cramer), fall armyworm (Spodoptera frugiperda J. E. Smith), bect armyworm (Spodoptera exigua Hübner), cotton leafworm (Spodoptera littoralis Boisduval), yellowstriped armyworm (Spodoptera ornithogalli Guenéc), black cutworm (Agrotis ipsilon Hufnagel), velvetbean caterpillar (Anticarsia gemmatalis Hübner), green fruitworm (Lithophane antennata Walker), cabbage armyworm (Barathra brassicae Linnaeus), soybean looper (Pseudoplusia includens Walker), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworms (Pyralidac: Crambinae) such as sod worm (Herpetogramma licarsisalis Walker), sugarcane stem borer (Chilo infuscatellus Snellen), tomato small borer (Neoleucinodes elegantalis Guenéc), green leafroller (Cnaphalocrocis medinalis), grape leaffolder (Desmia funeralis Hübner), melon worm (Diaphania nitidalis Stoll), cabbage center grub (Helluala hydralis Guenće), yellow stem borer (Scirpophaga incertulas Walker), early shoot borer (Scirpophaga infuscatellus Snellen), white stem borer (Scirpophaga innotata Walker), top shoot borer (Scirpophaga nivella Fabricius), dark-headed rice borer (Chilo polychrysus Meyrick), striped riceborer (Chilo suppressalis Walker), cabbage cluster caterpillar (Crocidolomia binotalis English)); leafrollers, budworms, seed worms, and fruit worms in the family Tortricidae (e.g., codling moth (Cydia pomonella Linnaeus), grape berry moth (Endopiza viteana Clemens), oriental fruit moth (Grapholita molesta Busck), citrus false codling moth (Cryptophlebia leucotreta Meyrick), citrus borer (Ecdytolopha aurantiana Lima), redbanded leafroller (Argyrotaenia velutinana Walker), obliquebanded leafroller (Choristoneura rosaceana Harris), light brown apple moth (Epiphyas postvittana Walker), European grape berry moth (Eupoecilia ambiguella Hübner), apple bud moth (Pandemis pyrusana Kearfott), omnivorous leafroller (Platynota stultana Walsingham), barred fruit-tree tortrix (Pandemis cerasana Hübner), apple brown tortrix (Pandemis heparana Denis & Schiffermüller)); and many other economically important lepidoptera (e.g., diamond back moth (Plutella xylostella Linnacus), pink bollworm (Pectinophora gossypiella Saunders), gypsy moth (Lymantria dispar Linnacus), peach fruit borer (Carposina niponensis Walsingham), peach twig borer (Anarsia lineatella Zeller), potato tuberworm (Phthorimaea operculella Zeller), spotted teniform leafminer (Lithocolletis blancardella Fabricius), Asiatic apple leafminer (Lithocolletis ringoniella Matsumura), rice leaffolder (Lerodea eufala Edwards), apple leafminer (Leucoptera scitella Zeller)); eggs, nymphs and adults of the order Blattodea including cockroaches from the families Blattellidae and Blattidae (e.g., oriental cockroach (Blatta orientalis Linnacus), Asian cockroach (Blatella asahinai Mizukubo), German cockroach (Blattella germanica Linnaeus), brownbanded cockroach (Supella longipalpa Fabricius), American cockroach (Periplaneta americana Linnacus), brown cockroach (Periplaneta brunnea Burmeister), Madeira cockroach (Leucophaea maderae Fabricius)), smoky brown cockroach (Periplaneta fuliginosa Service), Australian Cockroach (Periplaneta australasiae Fabr.), lobster cockroach (Nauphoeta cinerea Olivier) and smooth cockroach (Symploce pallens Stephens)); eggs, foliar feeding, fruit feeding, root feeding, seed feeding and vesicular tissue feeding larvae and adults of the order Coleoptera including weevils from the families Anthribidac, Bruchidac, and Curculionidac (e.g., boll weevil (Anthonomus grandis Boheman), rice water weevil (Lissorhoptrus oryzophilus Kuschel), granary weevil (Sitophilus granarius Linnaeus), rice weevil (Sitophilus oryzae Linnaeus)), annual bluegrass weevil (Listronotus maculicollis Dietz), bluegrass billbug (Sphenophorus parvulus Gyllenhal), hunting billbug (Sphenophorus venatus vestitus), Denver billbug (Sphenophorus cicatristriatus Fahracus)); flea beetles, cucumber beetles, rootworms, leaf beetles, potato beetles, and leafminers in the family Chrysomelidac (e.g., Colorado potato beetle (Leptinotarsa decemlineata Say), western corn rootworm (Diabrotica virgifera LeConte)); chafers and other beetles from the family Scarabacidac (e.g., Japanese beetle (Popillia japonica Newman), oriental beetle (Anomala orientalis Waterhouse, Exomala orientalis (Waterhouse) Baraud), northern masked chafer (Cyclocephala borealis Arrow), southern masked chafer (Cyclocephala immaculata Olivier or C. lurida Bland), dung beetle and white grub (Aphodius spp.), black turfgrass atacnius (Ataenius spretulus Haldeman), green June beetle (Cotinis nitida Linnaeus), Asiatic garden beetle (Maladera castanea Arrow), May/June beetles (Phyllophaga spp.) and European chafer (Rhizotrogus majalis Razoumowsky)); carpet beetles from the family Dermestidae; wireworms from the family Elateridae; bark beetles from the family Scolytidae and flour beetles from the family Tenebrionidac.

In addition, agronomic and nonagronomic pests include: eggs, adults and larvae of the order Dermaptera including earwigs from the family Forficulidac (e.g., European carwig (Forficula auricularia Linnacus), black carwig (Chelisoches morio Fabricius)); eggs, immatures, adults and nymphs of the orders Hemiptera and Homoptera such as, plant bugs from the family Miridac, cicadas from the family Cicadidac, leafhoppers (e.g. Empoasca spp.) from the family Cicadellidae, potato leafhoppers, bed bugs (e.g., Cimex lectularius Linnacus) from the family Cimicidae, planthoppers from the families Fulgoroidae and Delphacidae, trechoppers from the family Membracidae, psyllids from the family Psyllidae, whiteflies from the family Aleyrodidac, aphids from the family Aphididac, phylloxera from the family Phylloxeridae, mealybugs from the family Pseudococcidae, scales from the families Coccidac, Diaspididac and Margarodidac, lace bugs from the family Tingidae, stink bugs from the family Pentatomidac, chinch bugs (e.g., hairy chinch bug (Blissus leucopterus hirtus Montandon) and southern chinch bug (Blissus insularis Barber)) and other seed bugs from the family Lygacidae, spittlebugs from the family Cercopidae squash bugs from the family Coreidae, and red bugs and cotton stainers from the family Pyrrhocoridac.

Agronomic and nonagronomic pests also include: eggs, larvae, nymphs and adults of the order Acari (mites) such as spider mites and red mites in the family Tetranychidac (e.g., European red mite (Panonychus ulmi Koch), two spotted spider mite (Tetranychus urticae Koch), McDaniel mite (Tetranychus mcdanieli McGregor)); flat mites in the family Tenuipalpidac (e.g., citrus flat mite (Brevipalpus lewisi McGregor)); rust and bud mites in the family Eriophyidae and other foliar feeding mites and mites important in human and animal health, i.e., dust mites in the family Epidermoptidae, follicle mites in the family Demodicidac, grain mites in the family Glycyphagidae; ticks in the family Ixodidae, commonly known as hard ticks (e.g., deer tick (Ixodes scapularis Say), Australian paralysis tick (Ixodes holocyclus Neumann), American dog tick (Dermacentor variabilis Say), lone star tick (Amblyomma americanum Linnacus)) and ticks in the family Argasidae, commonly known as soft ticks (e.g., relapsing fever tick (Ornithodoros turicata), common fowl tick (Argas radiatus)); scab and itch mites in the families Psoroptidac, Pyemotidac, and Sarcoptidae; eggs, adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria Linnaeus), bush locust (Zonocerus spp.), house cricket (Acheta domesticus Linnaeus), mole crickets (e.g., tawny mole cricket (Scapteriscus vicinus Scudder) and southern mole cricket (Scapteriscus borellii Giglio-Tos)); eggs, adults and immatures of the order Diptera including leafminers (e.g., Liriomyza spp. such as serpentine vegetable leafminer (Liriomyza sativae Blanchard)), midges, fruit flies (Tephritidac), frit flies (e.g., Oscinella frit Linnaeus), soil maggots, house flies (e.g., Musca domestica Linnaeus), lesser house flies (e.g., Fannia canicularis Linnacus, F. femoralis Stein), stable flies (e.g., Stomoxys calcitrans Linnaeus), face flies, horn flies, blow flies (e.g., Chrysomya spp., Phormia spp.), and other muscoid fly pests, horse flies (e.g., Tabanus spp.), bot flies (e.g., Gastrophilus spp., Oestrus spp.), cattle grubs (e.g., Hypoderma spp.), deer flies (e.g., Chrysops spp.), keds (e.g., Melophagus ovinus Linnacus) and other Brachycera, mosquitoes (e.g., Aedes spp., Anopheles spp., Culex spp.), black flies (e.g., Prosimulium spp., Simulium spp.), biting midges, sand flies, sciarids, and other Nematocera; eggs, adults and immatures of the order Thysanoptera including onion thrips (Thrips tabaci Lindeman), flower thrips (Frankliniella spp.), and other foliar feeding thrips; insect pests of the order Hymenoptera including ants of the Family Formicidae including the Florida carpenter ant (Camponotus floridanus Buckley), red carpenter ant (Camponotus ferrugineus Fabricius), black carpenter ant (Camponotus pennsylvanicus De Geer), white-footed ant (Technomyrmex albipes fr. Smith), big headed ants (Pheidole sp.), ghost ant (Tapinoma melanocephalum Fabricius); Pharaoh ant (Monomorium pharaonis Linnaeus), little fire ant (Wasmannia auropunctata Roger), fire ant (Solenopsis geminata Fabricius), red imported fire ant (Solenopsis invicta Buren), Argentine ant (Iridomyrmex humilis Mayr), crazy ant (Paratrechina longicornis Latreille), pavement ant (Tetramorium caespitum Linnaeus), cornfield ant (Lasius alienus Förster) and odorous house ant (Tapinoma sessile Say). Other Hymenoptera including bees (including carpenter bees), hornets, yellow jackets, wasps, and sawflics (Neodiprion spp.; Cephus spp.); insect pests of the order Isoptera including termites in the Termitidac (e.g., Macrotermes sp., Odontotermes obesus Rambur), Kalotermitidae (e.g., Cryptotermes sp.), and Rhinotermitidae (e.g., Reticulitermes sp., Coptotermes sp., Heterotermes tenuis Hagen) families, the eastern subterranean termite (Reticulitermes flavipes Kollar), western subterranean termite (Reticulitermes hesperus Banks), Formosan subterranean termite (Coptotermes formosanus Shiraki), West Indian drywood termite (Incisitermes immigrans Snyder), powder post termite (Cryptotermes brevis Walker), drywood termite (Incisitermes snyderi Light), southeastern subterranean termite (Reticulitermes virginicus Banks), western drywood termite (Incisitermes minor Hagen), arboreal termites such as Nasutitermes sp. and other termites of economic importance; insect pests of the order Thysanura such as silverfish (Lepisma saccharina Linnaeus) and firebrat (Thermobia domestica Packard); insect pests of the order Mallophaga and including the head louse (Pediculus humanus capitis De Geer), body louse (Pediculus humanus Linnaeus), chicken body louse (Menacanthus stramineus Nitszch), dog biting louse (Trichodectes canis De Geer), fluff louse (Goniocotes gallinae De Geer), sheep body louse (Bovicola ovis Schrank), short-nosed cattle louse (Haematopinus eurysternus Nitzsch), long-nosed cattle louse (Linognathus vituli Linnaeus) and other sucking and chewing parasitic lice that attack man and animals; insect pests of the order Siphonoptera including the oriental rat flea (Xenopsylla cheopis Rothschild), cat flea (Ctenocephalides felis Bouche), dog flea (Ctenocephalides canis Curtis), hen flea (Ceratophyllus gallinae Schrank), sticktight flea (Echidnophaga gallinacea Westwood), human flea (Pulex irritans Linnaeus) and other fleas afflicting mammals and birds. Additional arthropod pests covered include: spiders in the order Araneae such as the brown recluse spider (Loxosceles reclusa Gertsch & Mulaik) and the black widow spider (Latrodectus mactans Fabricius), and centipedes in the order Scutigeromorpha such as the house centipede (Scutigera coleoptrata Linnaeus).

Examples of invertebrate pests of stored grain include larger grain borer (Prostephanus truncatus), lesser grain borer (Rhyzopertha dominica), rice weevil (Stiophilus oryzae), maize weevil (Stiophilus zeamais), cowpea weevil (Callosobruchus maculatus), red flour beetle (Tribolium castaneum), granary weevil (Stiophilus granarius), Indian meal moth (Plodia interpunctella), Mediterranean flour beetle (Ephestia kuhniella) and flat or rusty grain beetle (Cryptolestis ferrugineus).

Compositions produced according to the present disclosure may have activity on members of the Classes Nematoda, Cestoda, Trematoda, and Acanthocephala including economically important members of the orders Strongylida, Ascaridida, Oxyurida, Rhabditida, Spirurida, and Enoplida such as but not limited to economically important agricultural pests (i.e., root knot nematodes in the genus Meloidogyne, lesion nematodes in the genus Pratylenchus, stubby root nematodes in the genus Trichodorus, etc.) and animal and human health pests (i.e., all economically important flukes, tapeworms, and roundworms, such as Strongylus vulgaris in horses, Toxocara canis in dogs, Haemonchus contortus in sheep, Dirofilaria immitis Leidy in dogs, Anoplocephala perfoliata in horses, Fasciola hepatica Linnaeus in ruminants, etc.).

Compositions produced according to the disclosure may have activity against pests in the order Lepidoptera (e.g., Alabama argillacea Hübner (cotton leaf worm), Archips argyrospila Walker (fruit tree leaf roller), A. rosana Linnaeus (European leaf roller) and other Archips species, Chilo suppressalis Walker (rice stem borer), Cnaphalocrosis medinalis Guenće (rice leaf roller), Crambus caliginosellus Clemens (corn root webworm), Crambus teterrellus Zincken (bluegrass webworm), Cydia pomonella Linnaeus (codling moth), Earias insulana Boisduval (spiny bollworm), Earias vittella Fabricius (spotted bollworm), Helicoverpa armigera Hübner (American bollworm), Helicoverpa zea Boddie (corn carworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae Linnaeus (large white butterfly), Pieris rapae Linnacus (small white butterfly), Plutella xylostella Linnaeus (diamond back moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)).

Compositions produced according to the disclosure may have significant activity on members from the order Homoptera including: Acyrthosiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosiphum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi Linnaeus (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxcra); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim Linnacus (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla).

Compositions produced according to this disclosure also may have activity on members from the order Hemiptera including: Acrosternum hilare Say (green stink bug), Anasa tristis De Geer (squash bug), Blissus leucopterus Say (chinch bug), Cimex lectularius Linnaeus (bed bug) Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Halymorpha halys Stål (brown marmorated stink bug), Leptoglossus corculus Say (leaf-footed pine seed bug), Lygus lineolaris Palisot de Beauvois (tarnished plant bug), Nezara viridula Linnaeus (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrips), Scirthothrips citri Moulton (citrus thrips), Sericothrips variabilis Beach (soybean thrips), and Thrips tabaci Lindeman (onion thrips); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

In some aspects, the compositions produced according to the disclosure are useful for controlling Western Flower Thrips (Frankliniella occidentalis). In some aspects, the compositions produced according to the disclosure are useful for controlling potato leafhopper (Empoasca fabae). In some aspects, the compositions produced according to the disclosure are useful for controlling cotton melon aphid (Aphis gossypii). In some aspects, the compositions produced according to the disclosure are useful for controlling diamond backmoth (Plutella xylostella L.). In some aspects, the compositions produced according to the disclosure are useful for controlling Silverleaf Whitefly (Bemisia argentifolii Bellows & Perring).

In cyantraniliprole aspects of the disclosure, the compositions produced according to the disclosure are effective against Coleoptera, Chrysomelidae, Cerotoma trifurcata bean leaf beetle, Chaetocnema concinna beet flea beetle, Epilachna varivestis Mexican bean beetle, Epitrix cucumeris potato flea beetle, Leptinotarsa decemlineata Colorado potato beetle, Oulema melanopus cereal leaf beetle, Oulema oryzae rice leaf beetle, Phyllotreta cruciiferae cabbage flea beetle, Phyllotreta striolata striped flea beetle, Psylliodes spp. flea beetles, Curculionidac, Anthonomus eugenii pepper weevil, Ceutorhynchus napi cabbage stem weevil, Ceutorhynchus quadridens cabbage seed-stalk curculio, Conotrachelus nenuphar plum curculio, Hypera bruneipennis Egyptian alfalfa weevil, Hypera postica alfalfa weevil, Lissorhoptrus oryzophilus rice water weevil, Nitidulidae, Meligethes acneus pollen beetle, blossom beetle, Scarabacidac, Cotinis nitida green June beetle, Phyllophaga spp. June beetles, grubs, Popillia japonica Japanese beetle, Diptera, Agromyzidac, Liromyza chinensis stone leek leafminer, Liromyza huidobrensis pea leafminer, Liriomyza sativae serpentine/vegetable leafminer, Liromyza trifolii American serpentine leafminer, Anthomyiidae, Delia antiqua onion fly, Delia platura seedcorn maggot, Muscidae, Atherigona oryzae rice seedling fly, Psilidae, Psila rosae carrot fly, Tephritidae, Anastrepha fraterculus South American fruit fly, Anastrepha ludens Mexican fruit fly, Anasterpha striata guava fruit fly, Bactrocera cucurbitae melon fly, Bactrocera dorsalis oriental fruit fly, Bactrocera oleae olive fly, Ceratitis capitata Mediterranean fruit fly, Chromatomyia horticola garden pea leafminer, Rhagoletis cerasi cherry fruit fly, Rhagoletis cingulata cherry fruit fly, Rhagoletis indifferens western cherry fruit fly, Rhagoletis pomonella apple maggot, Hemiptera, Aleyrodidac, Aleyrodes proletella cabbage whitefly, Bemisia tabaci sweet potato whitefly, cotton whitefly, Dialeurodes citri citrus whitefly, Trialeurodes vaporariorum, greenhouse whitefly, Aphididac, Acyrthosiphon pisum pea aphid, Aphis craccivora cowpea aphid, Aphis fabac black bean aphid, Aphis glycines soybean aphid, Aphis gossypii cotton aphid, melon aphid, Aphis nasturtii buckthorn aphid, Aphis pomi green apple aphid, Aphis spiraccola spirea aphid, Aulacorthum solani foxglove aphid, Brachycaudus persicae black peach aphid, Brevicoryne brassicae cabbage aphid, Chromaphis juglandicola European walnut aphid, Dysaphis plantaginea rosy apple aphid, Hyalopterus pruni mealy plum aphid, Lipaphis crysimi mustard aphid, turnip aphid, Macrosiphum euphorbiae potato aphid, Myzus persicae green peach aphid, peach potato aphid, Rhopalosiphum padi bird cherry oat aphid, Rhopalosiphum nymphacae plum aphid, Schizaphis graminum greenbug, Sitobion avenac English grain aphid, Therioaphis maculata spotted alfalfa aphid, Toxoptera citricida brown citrus aphid, oriental citrus aphid, Cicadellidae, Empoasca fabae leafhopper/jassid complex, Empoasca vitis green frogfly, Hortensia similis common green leafhopper, Idioscopus spp. mango leafhopper, Jacobiasca lybica cotton jassid, Nephotettix spp. rice green leafhopper complex, Typhlocyba rosae rose leafhopper, Typhlocyba pomaria white apple leafhopper, Coreidae Leptocorisa oratorius rice bug, rice car bug, paddy bug, Delphacidac, Nilaparvata lugens rice brown planthopper, Diaspididae, Aonidiella aurantii citrus scale, Flatidae, Metcalfa pruinosa citrus flatid planthopper, Pentatomidac, Euschistus spp. brown stinkbugs, Edessa spp. stink bugs, Psyllidac, Diaphorina citri Asian citrus psyllid, Paratrioza cockerelli potato psyllid, tomato psyllid, Trioza eugeniae eugenia psyllid, lillypilly psyllid, Hymenoptera Tenthredinidae, Hoplocampa testudinca European apple sawfly, Lepidoptera, Crambidac, Scirpophaga incertulas yellow (rice) stemborer, Gelechiidae, Anarsia lineatella peach twig borer, Keiferia lycopersicella tomato pinworm, Pectinophora gossypiella pink bollworm, Tuta absoluta tomato leafminer, Gracillariidae, Gracillaria theivora tea leafroller, Phyllonorycter blancardella spotted tentiform leafminer, Phyllonorycter coryfoliella nut leaf blister moth, Phyllonorycter crataegella apple blotch leafminer, Phyllonorycter ringoniella apple leafminer, Phyllonorycter elmaella western tentiform leafminer, Hesperiidae, Borbo cinara rice leafroller, Lyonetiidae, Leucoptera coffeella white coffee leafminer, Leucoptera scitella pear leaf blister moth, Lyonetia clerkella peach, leaf miner, Noctuidae, Agrotis segetum common cutworm, Alabama argillacea cotton leafworn, Autographa californica alfalfa looper, Barathra brassicae cabbage armyworm, Chrysodeixis chalcites green garden looper, Chrysodeixis criosoma green semi-looper, Earias insulana Egyptian bollworm, Earias vittella northern rough bollworm, Feltia subterranea granulate cutworm, Helicoverpa armigera American bollworm, cotton bollworm, Helicoverpa punctigera climbing cutworm, Heliothis virescens tobacco budworm, Helicoverpa zea corn earworm, Prodenia ornithogalli yellow-striped armyworm, Pseudaletia unipuncta true armyworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistidae, Phyllocnistis citrella citrus leafminer, Pieridae, Colias eurytheme alfalfa caterpillar, Leptophobia aripa green-eyed white, Pieris brassicae cabbage butterfly, large white, Pieris rapac imported cabbage worm, cabbage white, Plutellidae, Plutella xylostella diamondback moth, Pyralidae, Chilo suppressalis Asiatic rice stemborer, Cnaphalocerus medinalis rice leaffolder, Crocidolomia binotalis cabbage caterpillar, Desmia funeralis grape leaffolder, Diaphania indica cotton caterpillar, Diaphania nitidaltis melonworm, Hellula hydralis cabbage center grub, Hellula undalis cabbage webworm, Lerodea cufala rice leaffolder, Leucinodes orbonalis brinjal fruit borer, Maruca testulalis bean pod borer, Neoleucinodes elegantalis small tomato borer, Nymphula depunctalis rice caseworm, Ostrinia furnicalis Asian corn borer, Ostrinia nubilalis European corn borer, Sphingidac, Manduca sexta tomato hornworm, tobacco hornworm, Smerinthus spp. sphinx moths, Tortricidae, Adoxophyes orana summer fruit tortrix, Argyrotaenia pulchellana grape tortrix, Argyrotaenia velutinana red-banded leafroller, Choristoneura rosaceana oblique-banded leafroller, Eupoecilia ambiguella grape berry moth, Cydia pomonella codling moth, Cydia prunivora lesser apple worm, Grapholita molesta oriental fruit moth, Lobesia botrana grape vine moth, Pandemis heparana apple brown tortrix, Pandemis limitata three-lined leaf roller, Paramyelois transitella navel orangeworm, Platynota idaeusalis tufted apple bud moth, Platynota stultana omnivorus leafroller, Thysanoptera, Thripidae, Enneothrips flavens, Frankliniella fusca tobacco thrips, Frankliniella intonsa European flower thrips, Frankliniella occidentalis western flower thrips, Frankliniella schultzei common blossom thrips, Frankliniella tritici eastern flower thrips, Megalurothrips sjostedti cowpea thrips, Megalurothrips usitatus bean blossom thrips, Scirthothrips citri citrus thrips, Scirthothrips dorsalis yellow tea thrips, chilli thrips, Sericothrips variabilis soybean thrips, Stenchaetothrips biformis oriental rice thrips, Thrips arizonensis cotton thrips, Thrips meridionalis peach thrips, Thrips palmi melon thrips, and Thrips tabaci onion thrips, common cotton thrips.

In some cyantraniliprole aspects of the disclosure, the compositions produced according to the disclosure are effective against Leptinotarsa decemlineata Colorado potato beetle, Oulema oryzae rice leaf beetle, Phyllotreta cruciiferae cabbage flea beetle, Phyllotreta striolata striped flea beetle, Psylliodes spp. flea beetles, Anthonomus eugenii pepper weevil, Conotrachelus nenuphar plum curculio, Lissorhoptrus oryzophilus rice water weevil, Meligethes aeneus pollen beetle, blossom beetle, Liromyza chinensis stone leek leafminer, Liromyza huidobrensis pea leafminer, Liriomyza sativae serpentine/vegetable leafminer, Liromyza trifolii American serpentine leafminer, Delia antiqua onion fly, Delia platura seedcorn maggot, Psila rosae carrot fly, Bactrocera dorsalis oriental fruit fly, Bactrocera oleae olive fly, Ceratitis capitata Mediterranean fruit fly, Rhagoletis indifferens western cherry fruit fly, Rhagoletis pomonella apple maggot, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis fabae black bean aphid, Aphis gossypii cotton aphid, melon aphid, Aphis pomi green apple aphid, Aphis spiraceola spirea aphid, Aulacorthum solani foxglove aphid, Brevicoryne brassicae cabbage aphid, Dysaphis plantaginea rosy apple aphid, Lipaphis erysimi mustard aphid, turnip aphid, Macrosiphum euphorbiae potato aphid, Myzus persicae green peach aphid, peach potato aphid, Rhopalosiphum padi bird cherry oat aphid, Schizaphis graminum greenbug, Sitobion avenae English grain aphid, Toxoptera citricida brown citrus aphid, oriental citrus aphid, Empoasca vitis green frogfly, Idioscopus spp. mango leafhopper, Nilaparvata lugens rice brown planthopper, Aonidiella aurantii citrus scale, Euschistus spp. brown stinkbugs, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Thermesia gemmatalis velvetbean caterpillar, Trichoplusia ni cabbage looper, Phyllocnistis citrella citrus leafminer, Pieris brassicae cabbage butterfly, large white, Pieris rapae imported cabbage worm, cabbage white, Plutella xylostella diamondback moth, Chilo suppressalis Asiatic rice stemborer, Cnaphalocerus medinalis rice leaffolder, Leucinodes orbonalis brinjal fruit borer, Ostrinia furnicalis Asian corn borer, Ostrinia nubilalis European corn borer, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella intonsa European flower thrips, Frankliniella occidentalis western flower thrips, Scirthothrips citri citrus thrips, Scirthothrips dorsalis yellow tea thrips, chilli thrips, Thrips palmi melon thrips, and Thrips tabaci onion thrips, common cotton thrips.

In some cyantraniliprole aspects of the disclosure, the compositions produced according to the disclosure are effective against Conotrachelus nenuphar plum curculio, Liromyza huidobrensis pea leafminer, Liriomyza sativae serpentine/vegetable leafminer, Liromyza trifolii American serpentine leafminer, Bemisia tabaci sweet potato whitefly, cotton whitefly, Trialeurodes vaporariorum, greenhouse whitefly, Acyrthosiphon pisum pea aphid, Aphis craccivora cowpea aphid, Aphis gossypii cotton aphid, melon aphid, Brevicoryne brassicae cabbage aphid, Dysaphis plantaginea rosy apple aphid, Myzus persicae green peach aphid, peach potato aphid, Diaphorina citri Asian citrus psyllid, Paratrioza cockerelli potato psyllid, tomato psyllid, Scirpophaga incertulas yellow (rice) stemborer, Anarsia lineatella peach twig borer, Tuta absoluta tomato leafminer, Leucoptera coffeella white coffee leafminer, Alabama argillacea cotton leafworn, Helicoverpa armigera American bollworm, cotton bollworm, Helicoverpa punctigera climbing cutworm, Heliothis virescens tobacco budworm, Helicoverpa zea corn earworm, Pseudoplusia includens soybean looper, Sesamia inferens pink (rice) stemborer, Spodoptera eridania southern armyworm, Spodoptera exigua beet armyworm, Spodoptera frugiperda fall armyworm, Spodoptera littoralis cotton leafworm, Spodoptera litura cluster caterpillar, Phyllocnistis citrella citrus leafminer, Plutella xylostella diamondback moth, Chilo suppressalis Asiatic rice stemborer, Cnaphalocerus medinalis rice leaffolder, Choristoneura rosaceana oblique-banded leafroller, Eupoecilia ambiguella grape berry moth, Cydia pomonella codling moth, Grapholita molesta oriental fruit moth, Lobesia botrana grape vine moth, Frankliniella fusca tobacco thrips, Frankliniella occidentalis western flower thrips, Scirthothrips dorsalis yellow tea thrips, chilli thrips, Thrips palmi melon thrips, and Thrips tabaci onion thrips, common cotton thrips.

In chlorantraniliprole aspects of the disclosure, the compositions produced according to the disclosure are effective against: Coleoptera (Chrysomelida, Leptinotarsa decemlineata Colorado potato beetle, Curculionidae, Lissorhoptrus oryzophilus rice water weevil, Listronotus maculicollis annual bluegrass weevil, Oryzophagus oryzae rice water weevil, Sphenophorus spp. Billbug, Scarabaeidae Ataenius spretulus black turfgrass ataenius, Aphodius spp. scarab beetles, Cotinis nitida green June beetle, Cyclocephala spp. masked chafers, Exomala orientalis oriental beetle grub, Maladera castanea Asiatic garden beetle, Phyllophaga spp. June beetles, Popillia japonica Japanese beetle, and Rhizotrogus majalis European chafer); Diptera (Agromyzidae, Chromatomyia horticola garden pea leafminer, and Liriomyza spp. Leafminers); Hemiptera (Aleyrodidae, Bemisia spp. Whitefly, Trialeurodes abutiloneus bandedwinged whitefly, Cicadellidae, and Typhlocyba pomaria white apple leafhopper); Isoptera (Rhinotermitidae, Heterotermes tenuis sugarcane termite, Termitidae, Microtermes obesi sugarcane termite, and Odontotermes obesus sugarcane termite); and Lepidoptera (Arctiidae, Estigmene acrea saltmarsh caterpillar, Crambidae, Achyra rantalis garden webworm, Desmia funeralis grape leaffolder, Ostrinia nubilalis European corn borer, Gelechiidae, Anarsia lineatella peach twig borer, Keiferia lycopersicella tomato pinworm, Phthorimaea operculella potato tuberworm, Tuta absoluta S. American tomato pinworm, Geometridae, Operophthera brumata winter moth, Gracilaridae, Phyllocnistis citrella citrus leafminer, Lithocolletis ringoniella apple leafminer, Phyllonorycter blancardella spotted tentiform leafminer, Lyonetidae, Leucoptera spp. (ie: malifoliella, coffeella) coffee leafminer, pear leaf blister moth, Noctuidae, Agrotis ipsilon black cutworm, Alabama argillacea cotton leafworm, Amphipyra pyramidoides humped green fruitworm, Anticarsia gemmatalis velvetbean caterpillar, Autographa gamma common silver Y moth, Barathra brassicae cabbage armyworm, Earias spp. (ie: huegeliana, insulana, vitella) rough, spiny, northern rough bollworm, Helicoverpa spp. (ie: armigera, punctigera, zea) bollworms/budworms/fruitworms, Heliothis virescens tobacco budworm, Lithophane antennata green fruitworm, Mamestra brassicae cabbage moth, Orthosia hibisci green fruitworm, Phalaenoides glycinae grape vine moth, Phytometra acuta tomato semi-looper, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieridae, Pieris spp. (ie: brassica, rapae) large white, imported cabbageworm, Plutellidae, Plutella xylostella diamondback moth, Pyralidae, Amyelois transitella navel orangeworm, Chilo spp. (ie: infuscatellus, polychrysus, suppressalis) sugarcane/rice stem borers, Cnaphalocrocis medinalis rice leafroller, Crambus spp. sod webworm, Crocidolomia binotalis cabbage cluster caterpillar, Diaphania spp. (ie: hyalinata, nitidalis) melonworm, pickleworm, Diatraea saccharalis, Brazilian sugarcane borer, Elasmopalpus lignosellus lesser stalk borer, Evergestis rimosalis cross-stripped cabbageworm, Hedylepta indicata soybean leaffolder, Hellula spp. (ie: hydralis, undalis) cabbage centre-grub, cabbage webworm, Leucinodes orbonalis eggplant shoot and fruit borer, Maruca spp. pod borer, Neoleucinodes elegantalis tomato small borer, Scirpophaga spp. sugarcane/rice stem borer, Sesamia spp. (ie: inferens, nonagrioides) pink stem borer/corn stalk borer, Sphingidae, Manduca spp. (ie: quinquemaculata, sexta) tomato/tobacco hornworm, Tortricidae, Adoxophyes orana summer fruit tortrix, Argyrotaenia spp. (ie: pulchellana, velutinana) grape tortrix, redbanded leafroller, Bonagota cranaodes Brazilian apple leafroller, Carposina spp. (ie: niponensis, sasaki) peach fruit borer, peach fruit moth, Choristoneura rosaceana obliquebanded leafroller, Cryptophlebia leucotreta false codling moth, Cydia pomonella codling moth, Ecdytolopha aurantiana citrus borer, Endopiza vitana grape berry moth, Epiphyas postvittana light brown apple moth, Eupoecilia ambiguella European grape berry moth, Grapholita molesta oriental fruit moth, Lobesia botrana European grapevine moth, Pandemis spp. (ie: cerasana, heparana, barred fruit tree tortrix, limitata, pyrusana) apple brown tortrix, three-lined leafroller, apple pandemic, Platynota spp. (ie: idaeusalis, stultana) tufted apple bud moth, omnivorous leafroller, Zygaenidae, and Harrisina spp. (ie: americana, brillians) grapeleaf/western grapeleaf skeletonizer).

In some chlorantraniliprole aspects of the disclosure, the compositions produced according to the disclosure are effective against: Leptinotarsa decemlineata Colorado potato beetle, Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Phthorimaea operculella potato tuberworm, Tuta absoluta S. American tomato pinworm, Phyllocnistis citrella citrus leafminer, Phyllonorycter blancardella spotted tentiform leafminer, Leucoptera spp. (ie: malifoliella, coffeella) coffee leafminer, Agrotis ipsilon black cutworm, Alabama argillacea cotton leafworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Trichoplusia ni cabbage looper, Pieris spp. (ie: brassica, rapae) large white, imported cabbageworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Leucinodes orbonalis eggplant shoot and fruit borer, Scirpophaga spp. sugarcane/rice stem borer, Sesamia spp. (ie: inferens, nonagrioides) pink stem borer/corn stalk borer, Carposina spp. (ie: niponensis, sasaki) peach fruit borer, peach fruit moth, Choristoneura rosaceana obliquebanded leafroller, Cydia pomonella codling moth, Eupoecilia ambiguella European grape berry moth, Grapholita molesta oriental fruit moth, and Lobesia botrana European grapevine moth.

In some chlorantraniliprole aspects of the disclosure, the compositions produced according to the disclosure are effective against: Liriomyza spp. Leafminers, Bemisia spp. Whitefly, Trialeurodes abutiloneus bandedwinged whitefly, Heterotermes tenuis sugarcane termite, Microtermes obesi sugarcane termite, and Odontotermes obesus sugarcane termite), Ostrinia nubilalis European corn borer, Anarsia lineatella peach twig borer, Tuta absoluta S. American tomato pinworm, Anticarsia gemmatalis velvetbean caterpillar, Helicoverpa spp. (ie: armigera, punctigera, zea) bollworms/budworms/fruitworms, Heliothis virescens tobacco budworm, Pseudoplusia includens soybean looper, Spodoptera spp. (ie: exigua, frugiperda, littoralis) beet armyworm, fall armyworm, Egyptian cotton leafworm, Plutella xylostella diamondback moth, Amyelois transitella navel orangeworm, Chilo spp. (ie: infuscatellus, polychrysus, suppressalis) sugarcane/rice stem borers, Cnaphalocrocis medinalis rice leafroller, Diatraea saccharalis, Brazilian sugarcane borer, Scirpophaga spp. sugarcane/rice stem borer, Sesamia spp. (ie: inferens, nonagrioides) pink stem borer/corn stalk borer, Cydia pomonella codling moth, Grapholita molesta oriental fruit moth, and Lobesia botrana European grapevine moth.

The compositions produced according to the present disclosure are useful for protecting agronomic field crops other non-agronomic horticultural crops and plants from phytophagous invertebrate pests. This utility includes protecting crops and other plants (i.e., both agronomic and nonagronomic) that contain genetic material introduced by genetic engineering (i.e., transgenic) or modified by mutagenesis to provide advantageous traits. Examples of such traits include tolerance to herbicides, resistance to phytophagous pests (e.g., insects, mites, aphids, spiders, nematodes, snails, plant-pathogenic fungi, bacteria and viruses), improved plant growth, increased tolerance of adverse growing conditions such as high or low temperatures, low or high soil moisture, and high salinity, increased flowering or fruiting, greater harvest yields, more rapid maturation, higher quality and/or nutritional value of the harvested product, or improved storage or process properties of the harvested products. Transgenic plants can be modified to express multiple traits. Examples of plants containing traits provided by genetic engineering or mutagenesis include varieties of corn, cotton, soybean and potato expressing an insecticidal Bacillus thuringiensis toxin such as YIELD GARD®, KNOCKOUT®, STARLINK®, BOLLGARD®, NuCOTN® and NEWLEAF®, INVICTA RR2 PRO™, and herbicide-tolerant varieties of corn, cotton, soybean and rapeseed such as ROUNDUP READY®, LIBERTY LINK®, IMI®, STS® and CLEARFIELD®, as well as crops expressing N-acetyltransferase (GAT) to provide resistance to glyphosate herbicide, or crops containing the HRA gene providing resistance to herbicides inhibiting acetolactate synthase (ALS). The compositions produced according to the present disclosure may interact synergistically with traits introduced by genetic engineering or modified by mutagenesis, thus enhancing phenotypic expression or effectiveness of the traits or increasing the invertebrate pest control effectiveness of the present compounds and compositions. In particular, the compositions produced according to the present disclosure may interact synergistically with the phenotypic expression of proteins or other natural products toxic to invertebrate pests to provide greater-than-additive control of these pests, i.e., produce a combined effect greater than the sum of their separate effects.

Plants within the scope of the present disclosure include crops, vegetables, fruits, trees other than fruit trees, lawn, and other uses (flowers, biofuel plants and ornamental foliage). Crops include: corn, rice, wheat, barley, rye, oat, sorghum, cotton, soybean, peanut, buckwheat, beet, rapeseed, sunflower, sugar cane, tobacco, and others known in the art. Vegetables include: solanaceous vegetables (for example, eggplant, tomato, pimento, pepper and potato); cucurbitaceous vegetables (for example, cucumber, pumpkin, zucchini, water melon, and melon); cruciferous vegetables (for example, Japanese radish, white turnip, horseradish, kohlrabi, Chinese cabbage, cabbage, leaf mustard, broccoli, and cauliflower); asteraceous vegetables (for example, burdock, crown daisy, artichoke and lettuce); liliaceous vegetables (for example, green onion, onion, garlic and asparagus); ammiaceous vegetables (for example, carrot, parsley, celery and parsnip); chenopodiaceous vegetables (for example, spinach and Swiss chard); and lamiaceous vegetables (for example, Perilla frutescens, mint and basil). Fruits include: pomaceous fruits (for example, apple, pear, Japanese pear, Chinese quince and quince); stone fleshy fruits (for example, peach, plum, nectarine, Prunus mume, cherry fruit, apricot and prune); citrus fruits (for example, Citrus unshiu, orange, lemon, lime and grapefruit); nuts (for example, chestnut, walnuts, hazelnuts, almond, pistachio, cashew nuts and macadamia nuts); berry fruits (for example, blueberry, cranberry, blackberry, strawberry, and raspberry); grape; kaki; persimmon; olive; Japanese plum; banana; coffee; date palm; coconuts; and oil palm. Trees other than fruit trees include: tea; mulberry; and other trees (for example, ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, Taxus cuspidate, elm and Japanese horse chestnut), Sweet viburnum, Podocarpus macrophyllus, Japanese cedar, Japanese cypress, croton, Japanese spindletree, and Photinia glabra). Lawn uses include: sods (for example, Zoysia japonica, Zoysia matrella); bermudagrasses; bent grasses; festucae; ryegrasses. Flower uses include: rose, carnation, chrysanthemum, Eustoma, gypsophila, gerbera, marigold, salvia, petunia, verbena, tulip, aster, gentian, lily, pansy, cyclamen, orchid, lily of the valley, lavender, stock, ornamental cabbage, primula, poinsettia, gladiolus, cattleya, daisy, cymbidium and begonia. Bio-fuel plants include: jatropha, safflower, Camelina, switch grass, Miscanthus giganteus, Phalaris arundinacea, Arundo donax, kenaf, cassava, and willow.

All plants or any part of a plant can be treated in accordance with compositions produced according to the processes of the disclosure. The term “plants” as used herein is to be understood as all plants and plant populations such as, for example, desired and undesired wild plants or crop plants (including naturally occurring crop plants). Crop plants can be plants that can be obtained by conventional breeding and optimization methods or by biotechnological and genetic engineering methods or by combinations of these methods, including transgenic plants and including plant cultivars which can or cannot be protected by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, as well as roots, tubers and rhizomes. The plant parts also include harvested material, and vegetative and generative propagation material, for example cuttings, tubers, rhizomes, offshoots and seeds.

Treatment of the plants and plant parts with the compositions produced according to the processes of the present disclosure is carried out by direct contact with the plant or plant part, or by action on the plant's environment, habitat or storage space using customary treatment methods. For example, treatment as described herein can be by dipping, spraying, evaporating, atomizing, broadcasting, spreading-on, injecting and, in the case of propagation material—particularly in the case of seeds—by applying a layer of a coating comprising the composition, optionally with additional layers.

In one embodiment, the compositions produced according to the processes of the present disclosure are aerially delivered to plants. In another embodiment, the compositions produced according to the present disclosure are delivered by an unmanned aerial vehicle (UAV). In yet another embodiment, the compositions produced according to the present disclosure are delivered by a helicopter or fixed-wing airplane.

Wild plant species and plant cultivars, or those obtained by conventional biological breeding methods, such as crossing or protoplast fusion, and parts thereof, may be treated. Also, transgenic plants and plant cultivars obtained by genetic engineering methods, if appropriate in combination with conventional methods (Genetically Modified Organisms), and parts thereof are treated. Plants of the plant cultivars that are in each case commercially available or in use are treated according to the disclosure. Plant cultivars are to be understood as meaning plants having novel properties (“traits”) which have been obtained by conventional breeding, by mutagenesis or by recombinant DNA techniques. These can be cultivars, biotypes or genotypes.

The transgenic plants or plant cultivars (obtained by genetic engineering) that may be treated according to the disclosure include all plants which, by the genetic modification, received genetic material which imparted particular advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defense of the plants against animal and microbial pests, such as against insects, mites, phytopathogenic fungi, bacteria and/or viruses, and increased tolerance of the plants to certain herbicidally active compounds. Examples of transgenic plants include the important crop plants, such as cereals (wheat, rice), maize, soybeans, potatoes, sugar beet, tomatoes, peas and other vegetable varieties, cotton, tobacco, oilseed rape and fruit plants (with the fruits apples, pears, citrus fruits and grapes), and emphasis is given to maize, soybeans, potatoes, cotton, tobacco and oilseed rape. Traits include the increased defense of the plants against insects, arachnids, nematodes and slugs and snails by toxins formed in the plants, particularly those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (“Bt plants”). Other traits are the increased defense of plants against fungi, bacteria and viruses by systemic acquired resistance (SAR), systemin, phytoalexins, elicitors and resistance genes and correspondingly expressed proteins and toxins. Traits also include the increased tolerance of the plants to certain herbicidally active compounds, for example imidazolinones, sulfonylureas, glyphosate or phosphinotricin (for example the “PAT” gene). The genes which impart the desired traits in question can also be present in combinations with one another in the transgenic plants. Examples of “Bt plants” include maize varieties, cotton varieties, soybean varieties and potato varieties which are sold under the trade names YIELD GARD® (for example maize, cotton, soybeans), KnockOut® (for example maize), StarLink® (for example maize), Bollgard® (cotton), Nucotn® (cotton) and NewLeaf© (potato). Examples of herbicide-tolerant plants are maize varieties, cotton varieties and soybean varieties that are sold under the trade names Roundup Ready® (tolerance to glyphosate, for example maize, cotton, soybean). Liberty Link® (tolerance to phosphinotricin, for example oilseed rape), IMI© (tolerance to imidazolinones) and STS® (tolerance to sulfonylureas, for example maize). Herbicide-resistant plants (plants bred in a conventional manner for herbicide tolerance) include the varieties sold under the name Clearfield® (for example maize). The agricultural crops are selected from the group consisting of cereals, fruit trees, citrus fruits, legumes, horticultural crops, cucurbits, oleaginous plants, tobacco, coffee, tea, cocoa, sugar beet, sugar cane, and cotton.

Depending on the plant species or plant cultivars, their location and growth conditions (soils, climate, vegetation period, diet), the treatment according to the disclosure may also result in superadditive (“synergistic”) effects. Thus, for example, reduced application rates and/or a widening of the activity spectrum and/or an increase in the activity of the substances and compositions which can be used according to the disclosure, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

Crops that can be protected with the compositions produced according to the processes of this disclosure, for example, comprise cereals (wheat, barley, rye, oats, rice, maize, sorghum, etc.), fruit trees (apples, pears, plums, peaches, almonds, cherries, bananas, grapes, strawberries, raspberries, blackberries, etc.), citrus trees (oranges, lemons, mandarins, grapefruit, etc.), legumes (beans, peas, lentils, soybean, etc.), vegetables (spinach, lettuce, asparagus, cabbage, carrots, onions, tomatoes, potatoes, eggplants, peppers, etc.), cucurbitaceae (pumpkins, zucchini, cucumbers, melons, watermelons, etc.), oleaginous plants (sunflower, rape, peanut, castor, coconut, etc.), tobacco, coffee, tea, cocoa, sugar beet, sugar cane, and cotton.

To protect the agricultural crops, the compositions produced according to the processes of this disclosure can be applied to any part of the plant, or on the seeds before sowing, or on the soil in which the plant grows.

Non-agronomic uses refer to invertebrate pest control in the areas other than fields of crop plants. Nonagronomic uses of the compositions produced according to the present disclosure include control of invertebrate pests in stored grains, beans and other foodstuffs, and in textiles such as clothing and carpets. Nonagronomic uses of the compositions produced according to the present disclosure also include invertebrate pest control in ornamental plants, forests, in yards, along roadsides and railroad rights of way, and on turf such as lawns, golf courses and pastures. Nonagronomic uses of the compositions produced according to the present disclosure also include invertebrate pest control in houses and other buildings which may be occupied by humans and/or companion, farm, ranch, zoo or other animals. Nonagronomic uses of the compositions produced according to the present disclosure also include the control of pests such as termites that can damage wood or other structural materials used in buildings

Nonagronomic uses of the compositions produced according to the present disclosure also include protecting human and animal health by controlling invertebrate pests that are parasitic or transmit infectious diseases. The controlling of animal parasites includes controlling external parasites that are parasitic to the surface of the body of the host animal (e.g., shoulders, armpits, abdomen, inner part of the thighs) and internal parasites that are parasitic to the inside of the body of the host animal (e.g., stomach, intestine, lung, veins, under the skin, lymphatic tissue). External parasitic or disease transmitting pests include, for example, chiggers, ticks, lice, mosquitoes, flies, mites and fleas. Internal parasites include heartworms, hookworms and helminths. Compositions produced according to the present disclosure are suitable for systemic and/or non-systemic control of infestation or infection by parasites on animals. Compositions produced according to the present disclosure are particularly suitable for combating external parasitic or disease transmitting pests. Compositions produced according to the present disclosure are suitable for combating parasites that infest agricultural working animals, such as cattle, sheep, goats, horses, pigs, donkeys, camels, buffalos, rabbits, hens, turkeys, ducks, geese and bees; pet animals and domestic animals such as dogs, cats, pet birds and aquarium fish; as well as so-called experimental animals, such as hamsters, guinea pigs, rats and mice. By combating these parasites, fatalities and performance reduction (in terms of meat, milk, wool, skins, eggs, honey, etc.) are reduced, so that applying a composition of the present disclosure allows more economic and simple husbandry of animals.

The embodiments of this disclosure include:

Embodiment 1. A process of preparing an aqueous suspension of organic pesticides, the process comprising
I) forming a mixture comprising a source of at least one amorphous organic pesticide, water, and at least one formulation additive;
II) adding at least one crystalline of organic pesticide to the mixture;
III) crystallizing the at least one amorphous organic pesticide;
IV) optionally homogenizing the mixture;
V) optionally milling the mixture; and
VI) optionally thickening the mixture.

Embodiment 2. A process of preparing an aqueous suspension of organic pesticides, the process comprising
I) forming a mixture comprising
   A) a formulation additive,
   B) at least one crystalline organic pesticide, and
   C) water;
II) adding at least one amorphous organic pesticide to the mixture under conditions of agitation;
III) crystallizing the at least one amorphous organic pesticide;
IV) optionally homogenizing the mixture;
V) optionally milling the mixture; and
VI) optionally thickening the mixture.

Embodiment 3. The process of embodiment 1 or embodiment 2, wherein the formulation additive is selected from additional water, dispersants, anti-freeze agents, viscosity-modifying agents, antifoams, bactericides, surfactants, and combinations thereof.

Embodiment 4. The process of any one of embodiments 1-3, wherein the at least one amorphous organic pesticide has a melting point in the range of from about 55° C. to about 100° C.

Embodiment 5. The process of any one of embodiments 1-4, wherein the at least one amorphous organic pesticide has a solubility in water of from about 0.00 1 mg/L to about 100 mg/L at 25° C.

Embodiment 6. The process of any one of embodiments 1-5, wherein the at least one amorphous organic pesticide is in a form selected from a melt, a supercooled melt, a solid amorphous form, a liquid, a solution comprising an active ingredient and a water miscible solvent, and combinations thereof.

Embodiment 7. The process of any one of embodiments 1-6, wherein the at least one amorphous organic pesticide is selected from the group consisting of insecticides, fungicides, herbicides, and any combination thereof.

Embodiment 8. The process of embodiment 7, wherein the insecticide is selected from the group consisting of: indoxacarb, bifenthrin, gamma-cyhalothrin, and combinations thereof.

Embodiment 9. The process of embodiment 7, wherein the fungicide is selected from the group consisting of: difenoconazole, pyraclostrobin, picoxystrobin, and combinations thereof.

Embodiment 10. The process of embodiment 7, wherein the herbicide is selected from the group consisting of: beflubutamid, s-beflubutamid, rimisoxamid, bixlozone isoflex, napropamide, aclonifen, and combinations thereof.

Embodiment 11. The process of any one of embodiments 1 to 10 wherein the aqueous suspension of organic pesticides further comprises a safener.

Embodiment 12. The process of embodiment 11, wherein the safener is Cloquintocet-mexyl.

Embodiment 13. The process of any one of embodiments 1-12, wherein the at least one crystalline organic pesticide has a melting point of from about 55° C. to about 100° C.

Embodiment 14. The process of embodiment 13, wherein the at least one crystalline organic pesticide has a melting point of about 95° C.

Embodiment 15. The process of any one of embodiments 1-14, wherein the at least one crystalline organic pesticide has a solubility in water of from about 0.001 mg/L to about 100 mg/L at 25° C.

Embodiment 16. The process of embodiment 15, wherein the at least one crystalline organic pesticide has a solubility in water of about 0.2 mg/L at 25° C.

Embodiment 17. The process of any one of embodiments 1-16, wherein the at least one crystalline organic pesticide is selected from insecticides, fungicides, herbicides, and combinations thereof.

Embodiment 18. The process of any one of embodiments 1-17, wherein the at least one crystalline organic pesticide is an insecticide.

Embodiment 19. The process of embodiment 18, wherein the crystalline organic insecticide is selected from the group consisting of indoxacarb, chlorantraniliprole, cyantraniliprole, bifenthrin, gamma-cyhalothrin, and combinations thereof.

Embodiment 20. The process of any one of embodiments 1-19, wherein the process comprises a milling step, and wherein the mixture is milled with a device selected from the group consisting of attritor mills, bead mills, colloid mills, rotor-stators, jet mills, air classifying mills, ring mills, hammer mills, pin mills, puck mills, and combinations thereof.

Embodiment 21. The process of any one of embodiments 1-20, wherein the process step of adding at least one amorphous organic pesticide to the mixture occurs at a temperature in the range of about 50° C. to about 100° C.

Embodiment 22. The process of embodiment 21, wherein the process step of adding at least one amorphous organic pesticide to the mixture occurs at a temperature in the range of about 50° C. to about 95° C.

Embodiment 23. The process of any one of Embodiments 1-22, wherein the at least one additive comprises at least one dispersant, at least one non-ionic surfactant, and at least one anionic surfactant.

Embodiment 24. The process of Embodiment 23, wherein the at least one dispersant is an acrylic copolymer solution.

Embodiment 25. The process of Embodiment 24, wherein the acrylic copolymer solution comprises propylene glycol, from about 30% to about 35% acrylic copolymer.

Embodiment 26. The process of Embodiment 25, wherein the acrylic copolymer solution further comprises water and methyl ethyl ketone.

Embodiment 27. The process of any one of Embodiments 23-26, wherein the dispersant content in the aqueous suspension of organic pesticides is from about 0.1 wt. % to about 15 wt. % from about 1 wt. % to about 10 wt. %, from about 0.5 wt. % to about 5 wt. %, or from about 0.5 wt. % to about 3 wt. %.

Embodiment 28. The process of any one of Embodiments 23-27, wherein the at least one anionic surfactant is: (1) tristyrylphenol ethoxylate phosphsate ester or a phosphate ester salt of ethoxylate alcohol; (2) sodium decyl sulfate and sodium lauryl sulfate; or (3) a combination thereof.

Embodiment 29. The process of Embodiment 28, wherein: (1) the phosphate ester salt of ethoxylate alcohol comprises from about 39% to about 43% alcohol and from about 4% to about 6% ethoxylated alcohol; and (2) the sodium decyl sulfate and sodium lauryl sulfate comprises from about 28% to about 32% sodium decyl sulfate and from about 5% to about 10% sodium lauryl sulfate, and further comprises from about 50% to about 60% water.

Embodiment 30. The process of any one of Embodiments 23-29, wherein at least one anionic surfactant content in the aqueous suspension of organic pesticides is from about 2 wt. % to about 25 wt. %, from about 2.5 wt. % to about 20 wt. %, from about 2.5 wt. % to about 15 wt. %, from about 2.5 wt. % to about 10 wt. %, or from about 5 wt. % to about 10 wt. %.

Embodiment 31. The process of any one of Embodiments 23-30, wherein the at least one nonionic surfactant is an alkyl polyglycoside.

Embodiment 32. The process of Embodiment 31, wherein the at least one nonionic surfactant is oligomeric D-glucopyranose, C9-11 alkyl glycoside.

Embodiment 33. The process of any one of Embodiments 23-32, wherein at least one nonionic surfactant content in the aqueous suspension of organic pesticides is from about 1 wt. % to about 10 wt. %, or from about 2 wt. % to about 10 wt. %.

Embodiment 34. The process of any one of Embodiments 23-33, wherein the ratio of the at least one nonionic surfactant to the at least one anionic surfactant is from about 5:1 to about 1:1, from about 3.5:1 to about 1:1, from about 3.5:1 to about 1.5:1, from about 3.25:1 to about 1.75:1, from about 3:1 to about 1.75:1, from about 2.75:1 to about 1.75:1, or from about 2.75:1 to about 1.5:1.

Embodiment 35. The process of any one of Embodiments 23-34, wherein the at least one additive further comprises at least one anti-freeze component and at least one antifoam.

Embodiment 36. The process of Embodiment 35, wherein the at least one anti-freeze component is glycerin, propylene glycol, or a combination thereof.

Embodiment 37. The process of Embodiment 35 or Embodiment 36, wherein the at least one antifoam is poly dimethyl siloxane.

Embodiment 38. The process of Embodiment 37, wherein the poly dimethyl siloxane antifoam is an emulsion comprising from about 30% to about 40% solids.

Embodiment 39. The process of any one of embodiments 1-38, wherein the process step of crystallizing the at least one amorphous organic pesticide comprises
A) mixing the mixture; and
B) optionally cooling the mixture.

Embodiment 40. The process of embodiment 39, wherein the crystallizing step is done in the absence of a precipitation step.

Embodiment 41. The process of any one of embodiments 1-40, wherein the process is performed in absence of a non-aqueous solvent.

Embodiment 42. The process of any one of embodiments 1-41, wherein the at least one amorphous organic pesticide is the same pesticide as the at least one crystalline organic pesticide.

Embodiment 43. The process of embodiment 42, wherein the amorphous organic pesticide and the crystalline organic pesticide are each indoxacarb.

Embodiment 44. The process of any of one embodiments 1-41, wherein the at least one amorphous organic pesticide is a different pesticide than the at least one crystalline organic pesticide.

Embodiment 45. The process of any one of embodiments 1-44, wherein the aqueous suspension of organic pesticide comprises at least 200, at least 250, or at least 300 grams per liter active ingredient of the crystalline organic pesticide.

Embodiment 46. An aqueous suspension of organic pesticides produced according to any one of embodiments 1-45.

Embodiment 47. An aqueous pesticide formulation produced according to any one of embodiments 1-45.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever.

The following components were used in the Example 1.

| Component | Description | CAS# |
|---|---|---|
| Indoxacarb Crystalline | Methyl (S)-N-[7-chloro-2,3,4a,5-tetrahydro-4a- | 1689545-27-4 |
| Technical (98%) | (methoxycarbonyl)indeno[1,2-e][1,3,4]oxadiazin-2- | |
| | ylcarbonyl]-4′-(trifluoromethoxy)carbanilate | |
| Indoxacarb Melt | Methyl (S)-N-[7-chloro-2,3,4a,5-tetrahydro-4a- | 1689545-27-4 |
| Technical (about 94%) | (methoxycarbonyl)indeno[1,2-e][1,3,4]oxadiazin-2- | |
| | ylcarbonyl]-4′-(trifluoromethoxy)carbanilate | |
| Rynaxypyr ® | 3-Bromo-N-[4-chloro-2-methyl-6- | 500008-45-7 |
| (Chlorantraniliprole) | (methylcarbamoyl)phenyl]-1-(3-chloropyridin-2-yl)- | |
| Technical | 1H-pyrazole-5-carboxamide | |
| Atlox 4913 (non-ionic | Acrylic copolymer solution (Methacrylic acid, | 119724-54-8 |
| surfactant; dispersant) | polyethylene oxide copolymer). Contains propylene | |
| | glycol, acrylic copolymer, water and methylethyl | |
| | ketone; 33% active. | |
| Dextrol OC-180 | Poly(oxy-1,2-ethanediyl),.alpha.-tridecyl-.omega.- | 68186-36-7 |
| (neutralized | hydroxy-, Phosphate potassium salt, 39.50%; | 78330-21-9 |
| ethoxylated aliphatic | Alcohols, C₁₁₋₁₄ iso, C₁₃ rich, ethoxylated, 6.00%. | |
| alcohol phosphate | | |
| ester; dispersant) | | |
| Agnique PG 9116 | D-glucopyranose, oligomeric, C₉₋₁₁-alkyl glycosides | 132778-08-6 |
| (non-ionic surfactant; | | |
| dispersant) | | |
| Polystep B25 U | Sodium decyl sulfate (SDS) (28-32%), | 142-87-0 |
| (anionic surfactant; | Sodium dodecyl (Lauryl) sulfate (5-10%), and | 151-21-3 |
| dispersant) | Water (50-60%) | |
| Glycerin | 1,2,3-trihydroxypropane | 56-81-5 |
| Xiameter AFE-0100 | Polydimethylsiloxane (concentrated) | 556-67-2 or |
| (antifoam) | | 631458-62-9 |
| Veegum R (thickener) | Magnesium aluminum silicate | 12199-37-0 or |
| | | 1302-78-9 |
| Rhodophol 23 slurry | Xantham gum (solution containing 0.1 Proxel GXL | 11138-66-2 |
| (thickener/emulsifier) | and 0.1% Actide LA) | |
| Proxel GL | 1,3-benzisothiazol-3-one | 2634-33-5 |
| (preservative) | | |
| Actide LG | 1.10% CIT (CMIT) (Kathon CG) + 0.37% MIT | |
| (preservative) | (Kathon ICP); Kathon ™ CG/ICP | |

Particle size measurements were done according to CIPAC method MT 187. A representative sample, dispersed at an adequate concentration in a suitable liquid or gas, is passed through the beam of a monochromatic light source, usually a laser. The light scattered by the particles at various angles is measured by a multi-element detector and numerical values relating to the scattering pattern are then recorded for subsequent analysis. These numerical scattering values are then transformed, using an appropriate optical model and mathematical procedure, to yield the proportion of total volume to a discrete number of size classes forming a volumetric particle size distribution.

X-ray diffractometer samples were analyzed using a Bruker D2 Phase Powder X-ray diffractometer instrument in a coupled Two Theta/Theta mode. The method included: (1) X-ray radiation from copper at 1.5406 Å; (2) X-ray power at 30-kV, 10-mA; and (3) the sample powder was dispersed on a standard PMMA sample holder (C79298A3244D82/D84). The general measurement conditions for pXRD were: 20 start angle=5°; 2θ stop angle=35°; sampling=0.02°; and scan speed=2°/min.

Differential scanning calorimeter samples were analyzed using a TA Q20 differential scanning calorimeter. DSC sample pans were either Tzero aluminum hermetic pans or high-pressure, gold-plated crucibles (Fauske M20), using between 4 and 6 mg of sample for each run. The method used a constant ramp rate of 2° C./min from 20° C. up to 140° C. and nitrogen as the purge gas at 50 mL/min. Peaks were integrated with a linear point-to-point baseline.

Microscopic analysis was done with a Leica DMI3000 B, manual inverted research microscope and with a Leica DMC6200 digital camera.

Scanning electron microscope imaging was performed on a FEI Quanta 205 FEG under high vacuum at 6.00 kV using a Everhardt-Thornly secondary electron detector (ETD). Six white powdered samples in liquid were dispensed in 100p L aliquots into 1 mL of distilled water in Eppendorf tubes. Each sample was vortexed for 20 seconds and then sonicated in a water bath for 1 minute. One 100 μL drop of the diluted sample was dispersed onto the center of a 12 mm SEM aluminum sample stub onto carbon tape and dried under vacuum for 1 hour. Each sample was coated with 4.0 to 5.0 nm of carbon using a Quorum 150RES carbon evaporator.

### Example 1

Crystalline indoxacarb was prepared in situ from a melt of amorphous indoxacarb.

A mixture of formulation ingredients was prepared in a jacketed beaker with agitation (about 300-500 rpm) by combining Atlox 4913 (14.5 g), Dextrol OC-180 (10.1 g), Agnique PG 9166 (28.0 g), Polystep B25 U (26.4 g), glycerin (24.0 g), Xiameter AFE (1.0 g), and water (119 g). The formulation mixture was heated to about 95° C.

Molten amorphous technical indoxacarb (184.0 g) was prepared by melting in an oven at about 95° C.

The indoxacarb melt was combined with the mixture of formulation ingredients with agitation (about 300-500 rpm) at about 95° C. The temperature was then reduced to about 85° C. and the admixture was maintained at temperature with agitation for about 1 hour. The temperature was then reduced to about 70-75° C. with agitation.

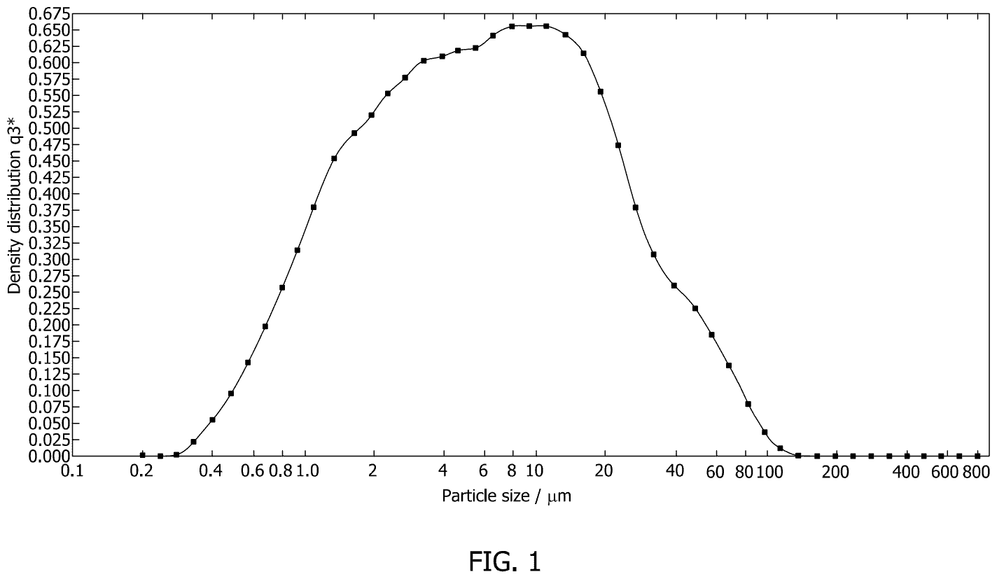

Indoxacarb crystalline technical (9.5 g) was added to the admixture with agitation (about 300 rpm) to form a slurry. Cooling was initiated and the slurry formed a crystalline mass. Cooling continued to about 5° C. The crystalline mass was broken up and homogenized to form a flowable suspension. The particle size distribution for the suspension of crystalline indoxacarb and aggregates thereof is depicted in FIG. 1. Water (70 g) was used to rinse out the beaker and was combined with the homogenized slurry. The resulting slurry was homogenized (deglomerated) for about 3 min with a Silverson L4RT homogenizer at about 4.5K rpm. The deglomerated slurry was transferred to an Eiger mill and was circulated and ground at about 5° C. at from about 2.5-3K rpm for about 40 minutes to produce a suspension of crystalline indoxacarb.

The milled suspension of crystalline indoxacarb was then thickened with Veegum R (8%) (5.7 g) and Rhodophol 23 slurry (2%) (19.0 g). The preservatives Proxel GXL (0.5 g) and Acticide LG (0.35 g) were added.

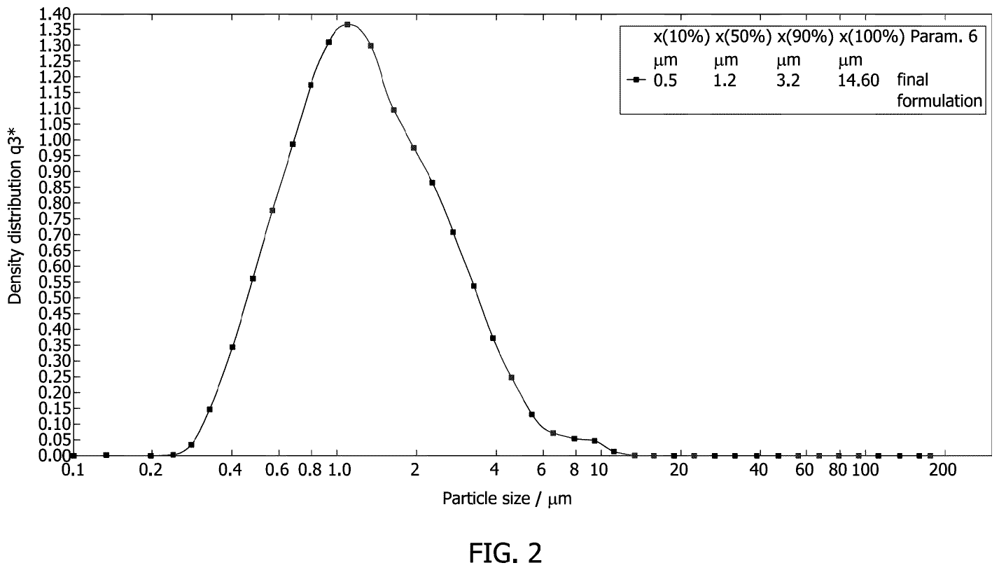

The composition of the final thickened milled suspension of crystalline indoxacarb is summarized in the following table and a particle size distribution thereof is depicted in FIG. 2:

| Component | Content |
|---|---|
| Indoxacarb Technical | 37.2% |
| Atlox 4913 | 2.8% |
| Dextrol OC-180 | 2.0% |
| Agnique PG 9116 | 5.5% |
| Polystep B25 U | 2.0% |
| Glycerin | 4.7% |
| Xiameter AFE-0100 | 0.2% |
| Veegum R | 0.2% |
| Rhodophol 23 | 0.1% |
| Proxel GL | 0.05% |
| Actide LG | 0.05% |
| Water | 45.3% |

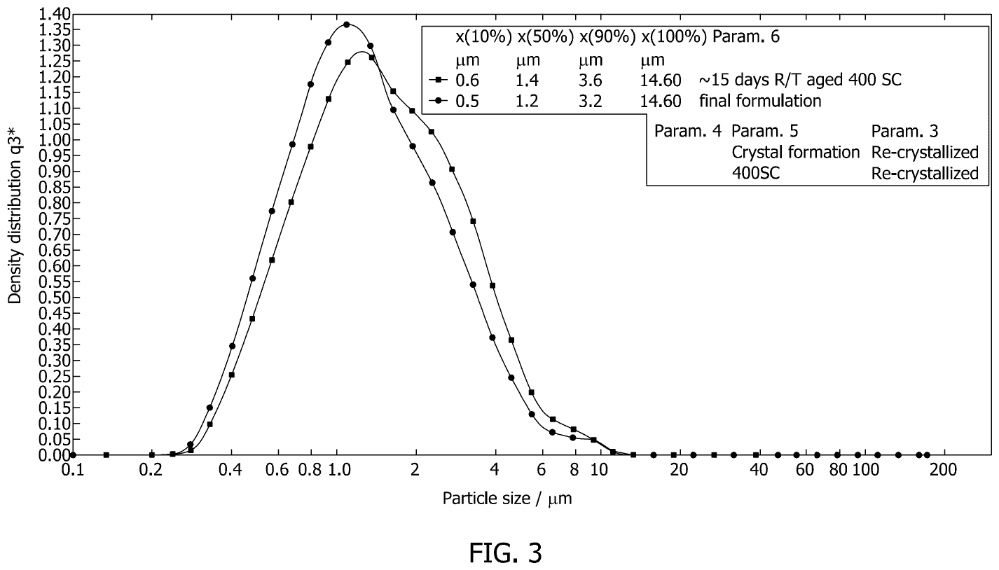

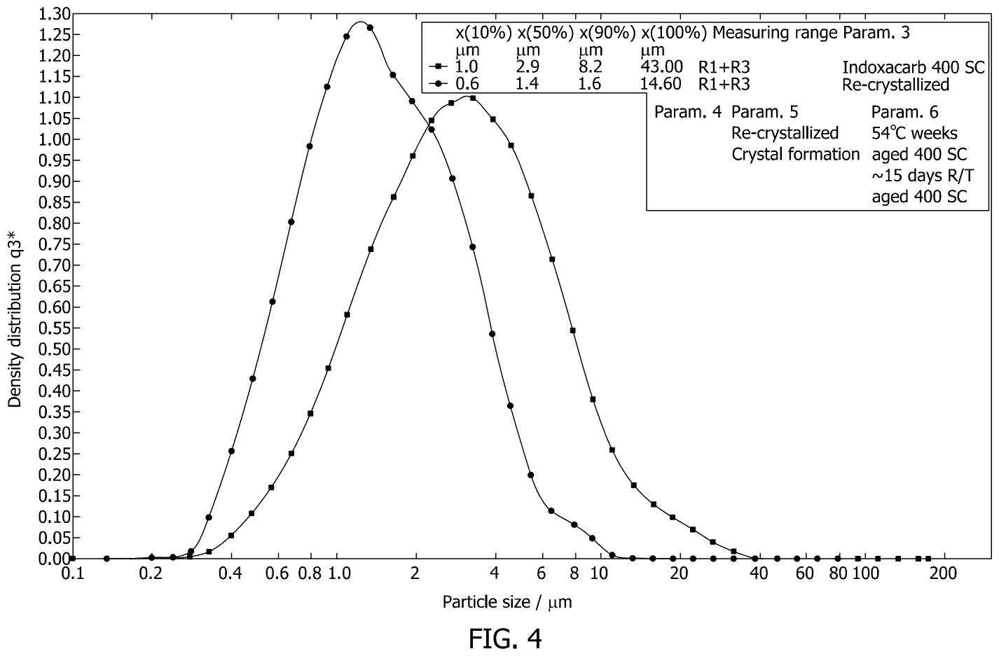

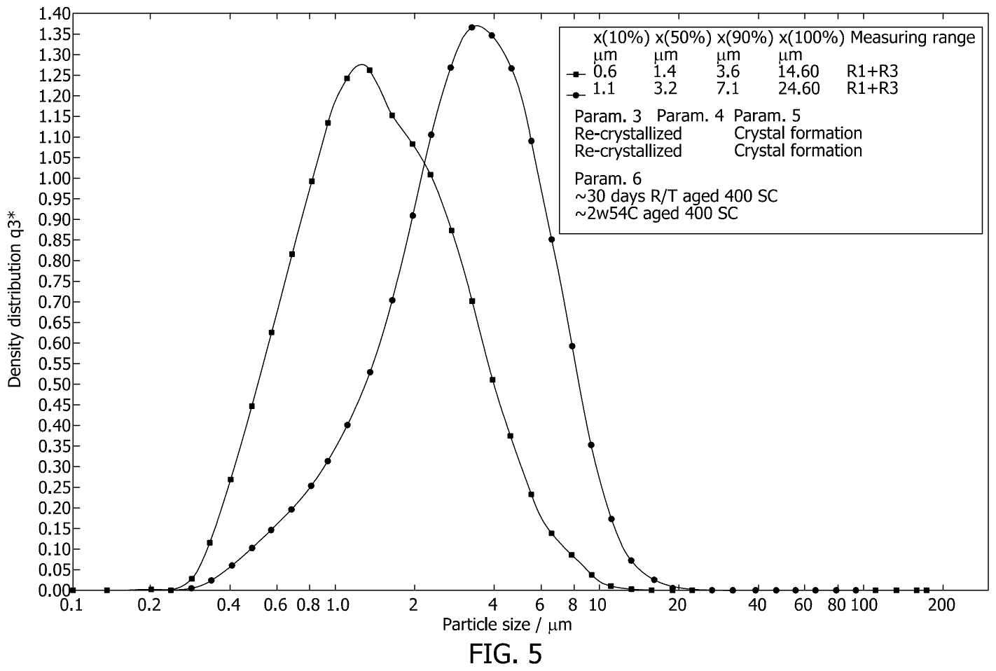

The final thickened milled suspension of crystalline indoxacarb was evaluated for particle size distribution at day 0, at day 15 after storage at room temperature, and at day 15 after storage at 54° C. The particle size results are shown in: FIG. 3 with the blue line indicating 15 days at RT and the red line indicating 0 days; FIG. 4 with the blue line indicating 15 days at RT and the red line indicating 2 weeks at 54° C.; and FIG. 5 with the blue line indicating 2 weeks at 54° C. and the red line indicating 30 days at RT. The results are also shown in the table below along with particle size distribution results for crystalline indoxacarb prepared according to Example 1 and for a technical concentrate (TC) prepared from crystalline indoxacarb prepared according to Example 1. Each of the evaluated compositions was an off-white suspension. In the table: “Indox. TC” refers to crystalline indoxacarb technical concentrate; “15 @RT” refers to 15 days at room temperature; “15 @54° C.” refers to 15 days at 54° C.; and the wet sieve was evaluated was 75 μm (200 mesh).

| | Example 1 | | Example 1 | | Example 1 | | Indox. TC | | Indox. TC | |
|---|---|---|---|---|---|---|---|---|---|---|
| Parameter | (day 0) | | (15 @ RT) | | (15 @ 54° C.) | | (15 @ RT) | | (15 @ 54° C.) | |
| Indoxacarb | 36.8 | (% w/w) | 36.8 | (% w/w) | 36.8 | (% w/w) | 36.8 | (% w/w) | 36.8 | (% w/w) |
| content | | | | | | | | | | |
| Density | — | | 1.16 | (g/mL) | 1.16 | (g/mL) | — | | — | |
| D(100) | 14.6 | (μ) | 14.6 | (μ) | 24.6 | (μ) | — | | — | |
| D(90) | 3.2 | (μ) | 3.6 | (μ) | 7.1 | (μ) | 4.8 | (μ) | 5.5 | (μ) |
| D(50) | 1.2 | (μ) | 1.4 | (μ) | 3.2 | (μ) | 1.9 | (μ) | 2.1 | (μ) |
| D(10) | 0.5 | (μ) | 0.6 | (μ) | 1.1 | (μ) | 0.8 | (μ) | 0.9 | (μ) |

| | | | | | |
|---|---|---|---|---|---|
| Wet sieve | ≥98% | ≥99.92% | ≥99.44% | — | ≥99.98% |

### Example 2

### Characterization by XRD, DSC, and SEM.

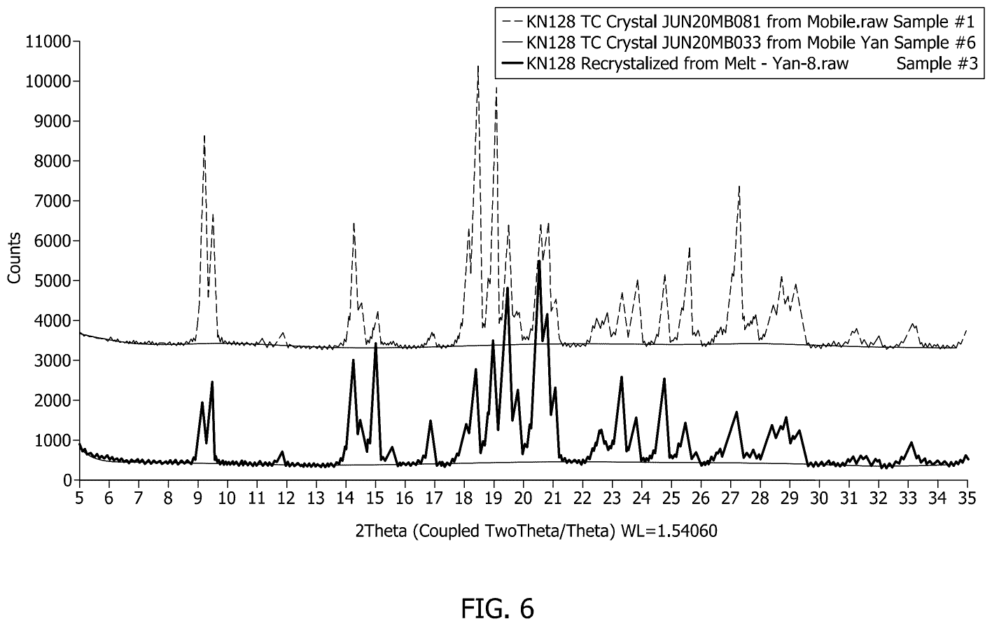

Sample formulation numbers 1 to 8 described in the table below were analyzed as indicated in the table by XRD (X-Ray Diffraction), DSC (Differential scanning calorimeter) thermal analysis, and SEM (Scanning Electron Microscopy). The results are reported in FIGS. 6-21.

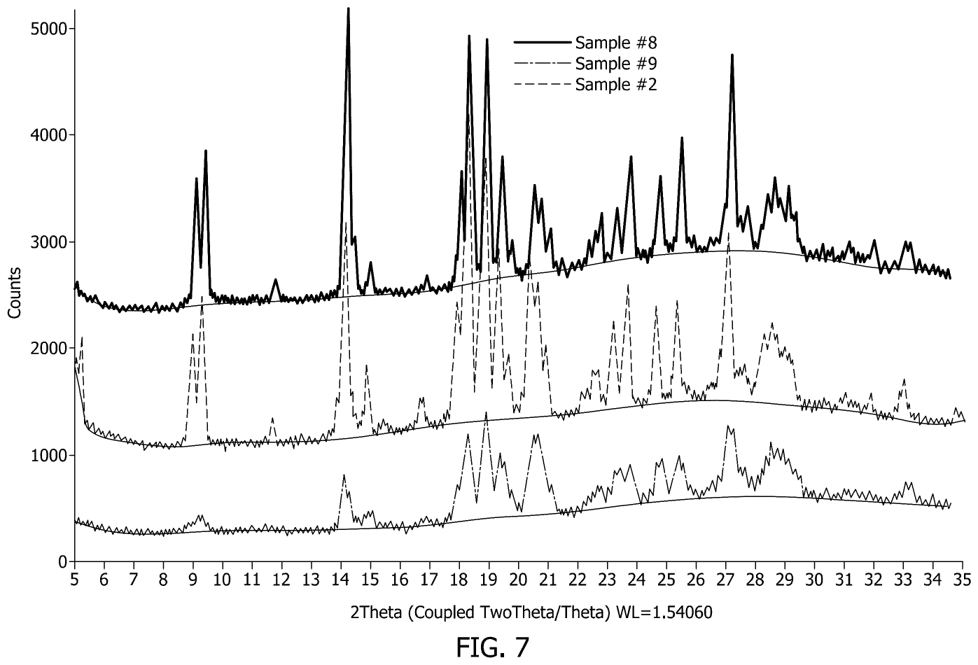

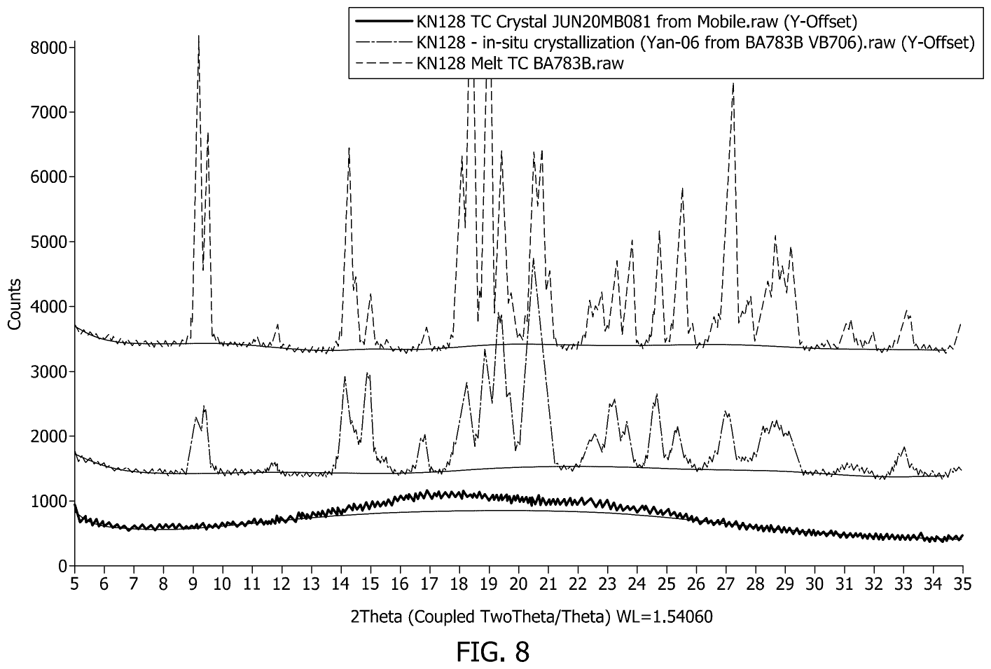

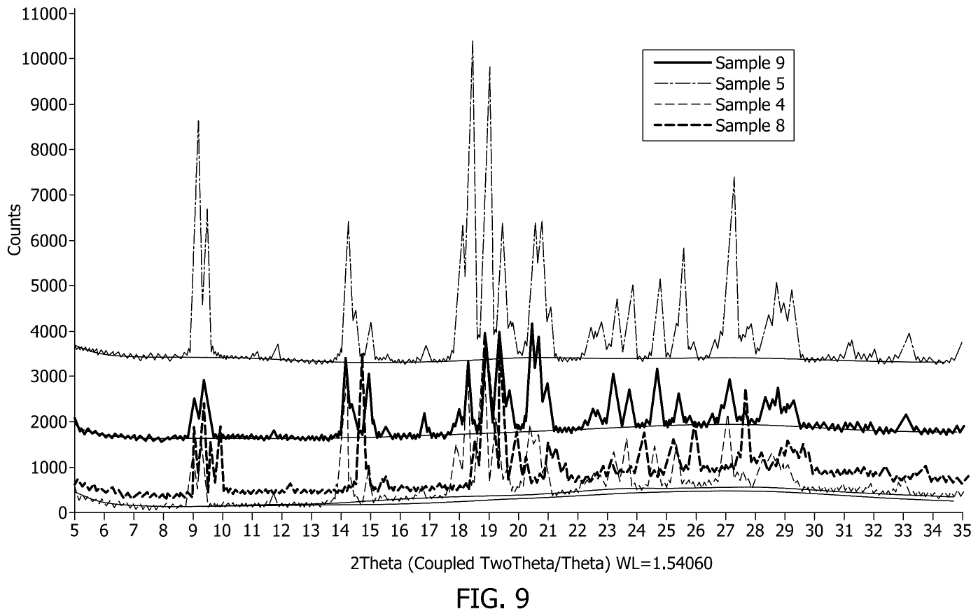

FIG. 6 reports XRD data for prior art crystalline indoxacarb samples 1 (black line) and 6 (yellow line), where the yellow and black lines are essentially identical and appear merged as the upper line of FIG. 6. FIG. 6 further reports XRD data for sample 3 of the present disclosure (red line (bottom line)). FIG. 6 shows that the prior art indoxacarb and the indoxacarb produced according to Example 1 are crystalline and have similar XRD patterns. FIG. 7 reports XRD data for prior art sample 8 (red line (upper line)), sample 2 of the present disclosure (orange line (middle line)), and sample 9 of the present disclosure (blue line (bottom line)). FIG. 7 shows that the prior art indoxacarb and the indoxacarb produced according to Example 1 are crystalline and have similar XRD patterns. FIG. 8 reports XRD data for prior art sample 1 (black line (upper line)), sample 9 of the present disclosure (magenta line (middle line)), and prior art sample 7 (brown line (bottom line)). FIG. 8 shows that the prior art indoxacarb and the indoxacarb produced according to Example 1 are crystalline and have similar XRD patterns, and that the prior art melt material used as the staring material for Example 1 is amorphous. FIG. 9 reports XRD data for prior art sample 1 (black line (upper line)), sample 5 of the present disclosure (green line (second line from the top)), prior art sample 8 (pink line (third line from the top)), sample 9 of the present disclosure (orange line (second line from the bottom)), and sample 4 of the present disclosure (light blue line (bottom line). FIG. 9 shows that the prior art indoxacarb and the indoxacarb produced according to Example 1 are crystalline and have similar XRD patterns.

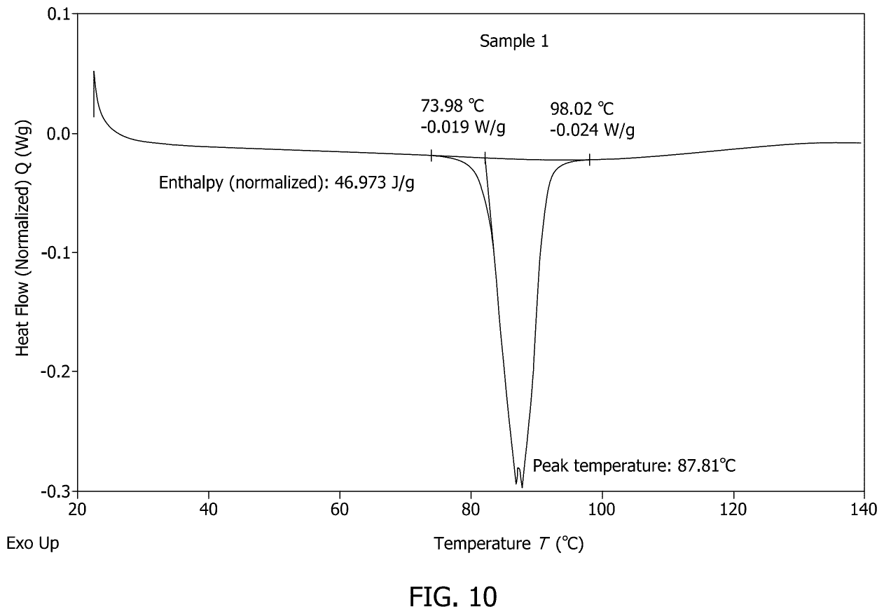

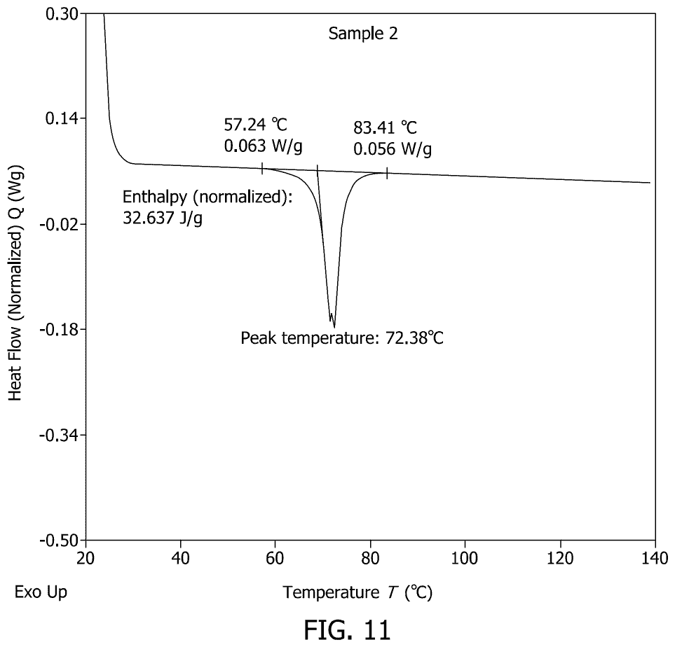

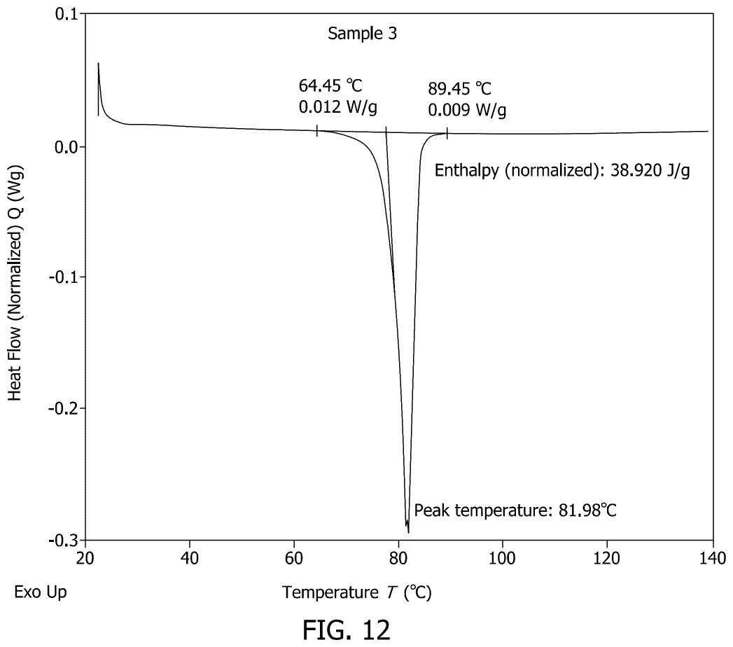

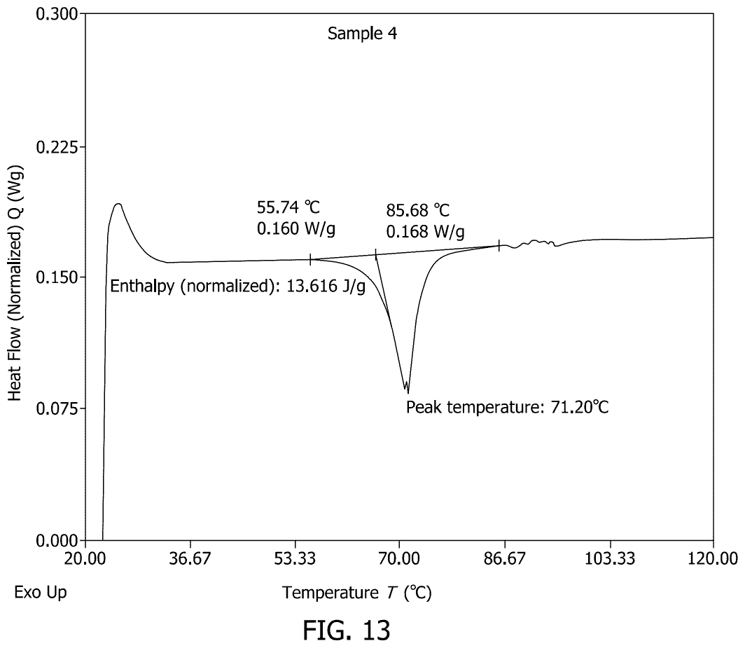

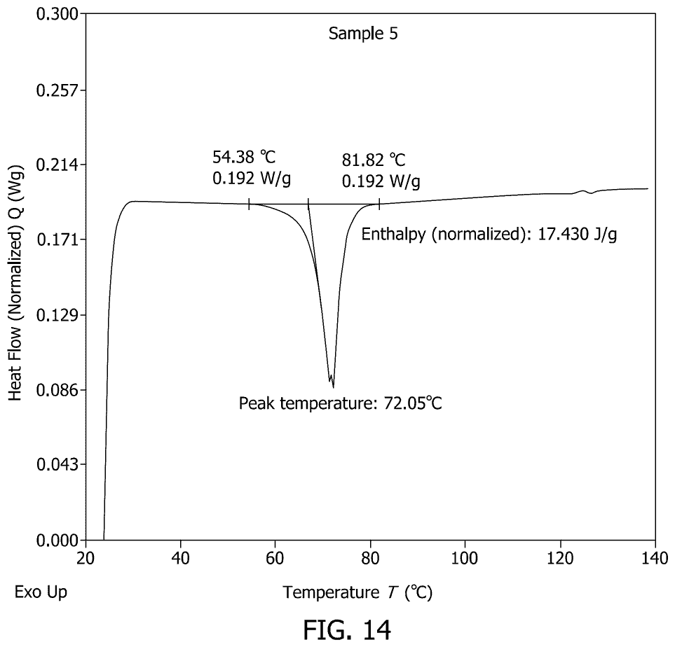

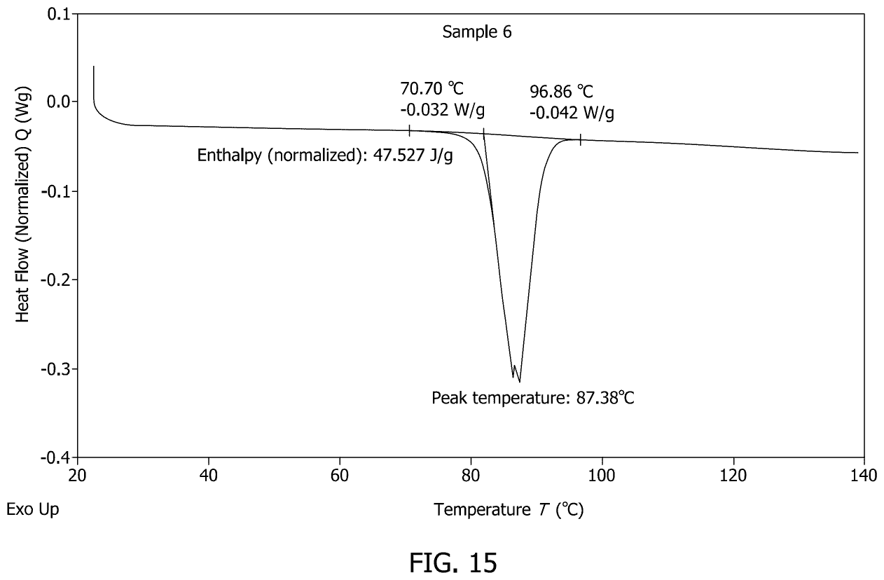

FIG. 10 reports DSC data for prior art sample 1. FIG. 11 reports DSC data for sample 2 of the present disclosure. FIG. 12 reports DSC data for sample 3 of the present disclosure. FIG. 13 reports DSC data for sample 4 of the present disclosure. FIG. 14 reports DSC data for sample 5 of the present disclosure. FIG. 15 reports DSC data for prior art sample 6.

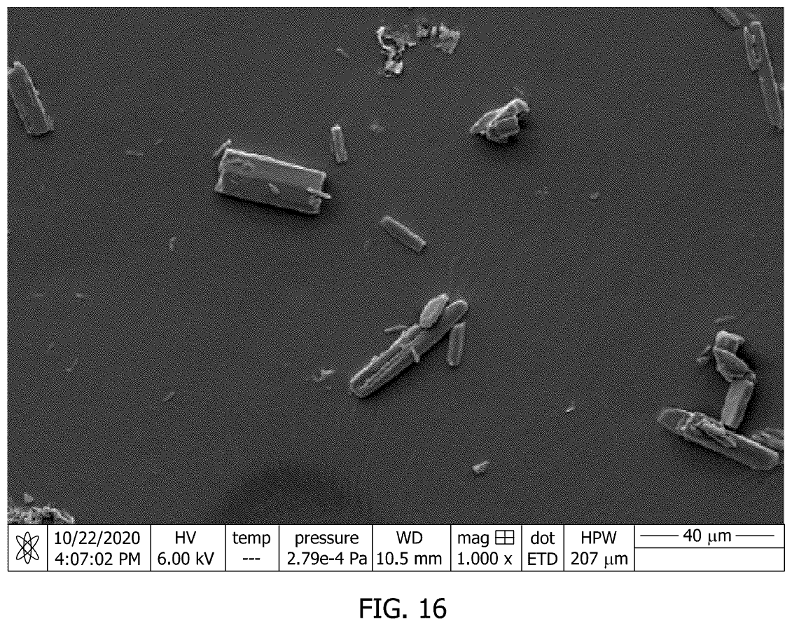

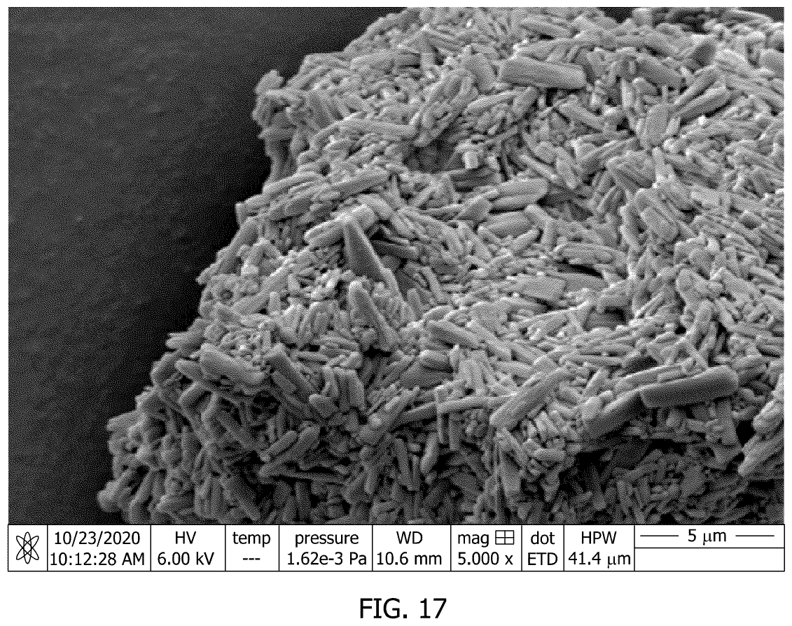

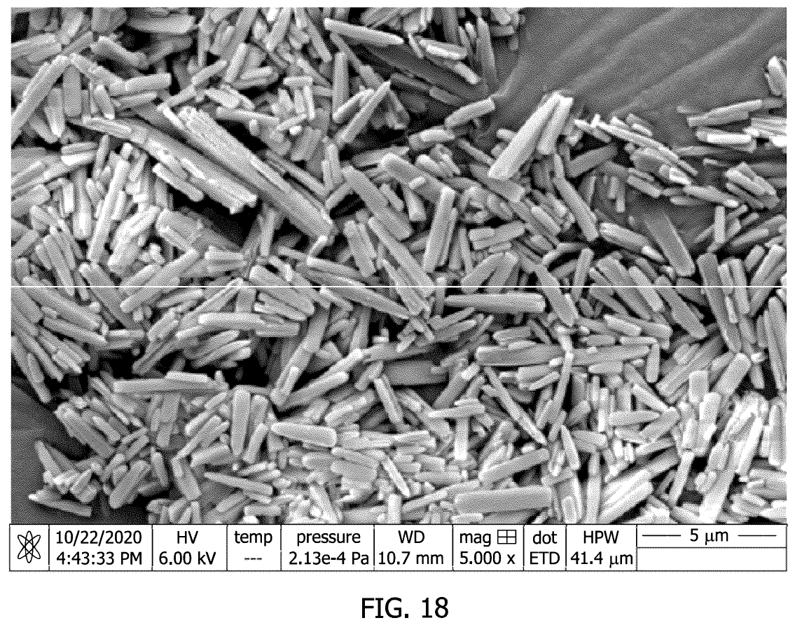

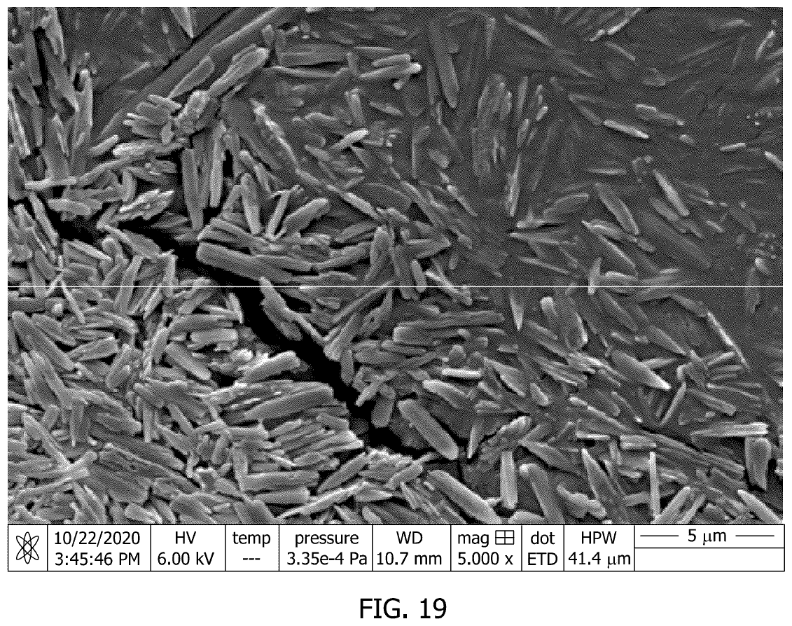

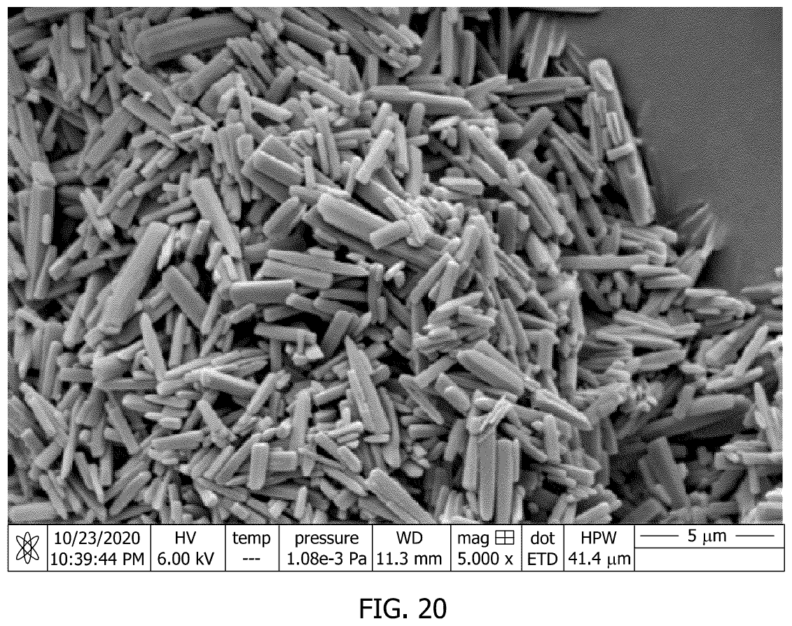

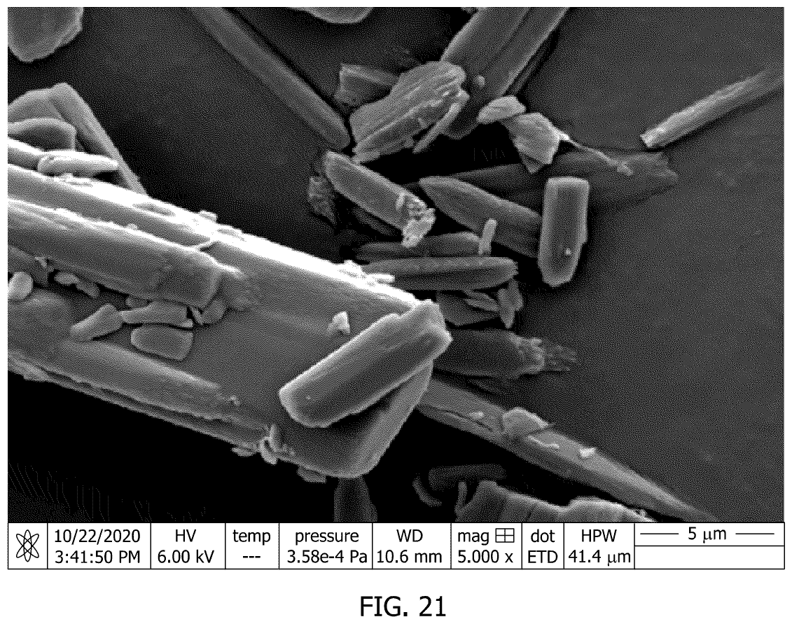

FIG. 16 depicts an SEM scan for prior art sample 1. FIG. 17 depicts an SEM scan for sample 2 of the present disclosure. FIG. 18 depicts an SEM scan for sample 3 of the present disclosure. FIG. 19 depicts an SEM scan for sample 4 of the present disclosure. FIG. 20 depicts an SEM scan for sample 5 of the present disclosure. FIG. 21 depicts an SEM scan for prior art sample 6.

| Sample No. | Description | XRD | DSC | SEM |
|---|---|---|---|---|
| 1 | A first lot of prior art crystalline | FIG. 6 | FIG. 10 | FIG. 16 |
| | indoxacarb | | | |
| 2 | 400 g/L SC formulation of | FIG. 7 | FIG. 11 | FIG. 17 |
| | crystalline indoxacarb prepared | | | |
| | according to Example 1 | | | |
| 3 | Re-crystallized crystalline | FIG. 6 | FIG. 12 | FIG. 18 |
| | indoxacarb prepared according to | | | |
| | Example 1 | | | |
| 4 | 400 g/L SC formulation of | FIG. 9 | FIG. 13 | FIG. 19 |
| | crystalline indoxacarb prepared | | | |
| | according to Example 1 aged at | | | |
| | room temperature for 20 days | | | |
| 5 | Crystalline indoxacarb prepared | FIG. 9 | FIG. 14 | FIG. 20 |
| | according to Example 1 | | | |
| | recrystallized from a melt | | | |
| 6 | A second lot of prior art crystalline | FIG. 6 | FIG. 15 | FIG. 21 |
| | indoxacarb | | | |
| 7 | Melt (amorphous) indoxacarb, | FIG. 8 | — | — |
| | technical, starting material for | | | |
| | Example 1 | | | |
| 8 | 300 g/L SC formulation of prior art | FIGS. 7 | — | — |
| | crystalline indoxacarb aged at room | and 9 | | |
| | temperature for 15 days | | | |
| 9 | 400 g/L SC formulation of | FIGS. 7, | — | — |
| | crystalline indoxacarb prepared | 8, and 9 | | |
| | according to Example 1 aged at | | | |
| | room temperature for 15 days | | | |

Samples 3 and 5 demonstrate that indoxacarb prepared by the in situ crystallization process of the present disclosure is crystalline. Samples 2, 4, and 9 demonstrate that crystalline indoxacarb prepared by the in situ crystallization process of the present disclosure can be directly formulated into an indoxacarb SC formulation. Samples 2, 4, and 9 further demonstrate that the crystalline indoxacarb SC formulations prepared via the in situ crystallization process of the present disclosure are stable in accelerated storage stability tests.

XRD (X-Ray Diffraction), DSC (Differential scanning calorimeter) thermal analysis, and SEM (Scanning Electron Microscopy) analysis confirmed that the crystalline indoxacarb formed via the in situ crystallization and one-pot formulation process of the present disclosure conforms to commercially available crystalline indoxacarb.

### Example 3

A mixture of crystalline indoxacarb and rynaxypyr was prepared in situ from a melt of amorphous indoxacarb and rynaxypyr.

A mixture of formulation ingredients was prepared in a jacketed beaker with agitation (about 300-500 rpm) by combining Atlox 4913 (19.07 g), Dextrol OC-180 (13.06 g), Agnique PG 9166 (37.56 g), Polystep B25 U (34.29 g), glycerin (31.39 g), Xiameter AFE (1.13 g), and water (202.12 g). The formulation mixture was heated to about 95° C.

Molten amorphous technical indoxacarb (178.00 g) was prepared by melting in an oven at about 95° C.

The indoxacarb melt was combined with the mixture of formulation ingredients with agitation (about 300-500 rpm) at about 95° C. The temperature was then reduced to about 85° C. and the admixture may be maintained at temperature with agitation for about 1 hour. The temperature may be then reduced to about 70-75° C. with agitation.

Rynaxypyr crystalline technical (2.35 g) was added to the admixture with agitation (about 300 rpm) to form a slurry. Cooling was initiated and the slurry formed a crystalline mass. Cooling may be continued to about 10° C. The crystalline mass was broken up and homogenized to form a flowable suspension. Water (32.32 g) was used to rinse out the beaker and may then be combined with the homogenized slurry. The resulting slurry was homogenized (deglomerated) for about 3 min with a Silverson L4RT homogenizer at about 4.5K rpm. The rynaxypyr technical (80.30 g) and Veegum R (0.65 g) were added into the deglomerated slurry, and the whole slurry was transferred to an Eiger mill and circulated and ground at about 5° C. and from about 2.5-3K rpm for about 40 minutes to produce a suspension comprising crystalline indoxacarb and rynaxypyr.

The milled suspension was then thickened with Rhodophol 23 slurry (2%) (24.0 g). The preservatives Acticide SPX (1.03 g) were added.

A composition of the final thickened milled suspension of crystalline indoxacarb and rynaxypyr was summarized in the following table:

| Component | Content |
|---|---|
| Indoxacarb Technical | 25.30% |
| Rynaxypyr Technical | 11.92% |
| Atlox 4913 | 2.8% |
| Dextrol OC-180 | 1.92% |
| Agnique PG 9116 | 5.52% |
| Polystep B25 U | 1.91% |
| Glycerin | 4.61% |
| Xiameter AFE-0100 | 0.17% |
| Veegum R | 0.1% |
| Rhodophol 23 | 0.07% |
| Acticide SPX | 0.15% |
| Water | 45.54% |

### Example 4

The insecticidal efficacy of crystalline indoxacarb suspension concentrates prepared according to Example 1 was evaluated on cotton plants as compared to a prior art Steward® indoxacarb emulsion concentrate. The insecticidal efficacy of crystalline indoxacarb suspension concentrates prepared according to Example 1 after a simulated rainfall event was evaluated on cotton plants as compared to the prior art Steward® indoxacarb emulsion concentrate.

Cotton plants were grown in a growth chamber until the appropriate size was reached. Test formulations were diluted and applied by spraying to two sets of the cotton plants using a Stine 215 Belt Sprayer (468 L/hectare, TwinJet 8002E, 2.1 bar, 19 cm, 43 meters/min). One set of plants was exposed to a “rainfall” event after two hours of drying time. Leaves were then cut and placed in high impact styrene trays with agar. An insect (second instar Spodoptera exigua) was placed in each cell and the cells were covered. There were two trays per treatment. The trays were held in a growth chamber under the conditions of 16:8 light:dark, 25° C., and 70% RH). The trays evaluated for insect mortality at 72 hours after infestation. The rainfall (washoff) event was done with a square nozzle suspended about 3 meters above the floor of the greenhouse at a pressure about 0.28 bar with a rotation of 1 revolution per minute. The washoff amount was about 7.2 cm of water in 60 minutes.

The tested sample formulations and the associated evaluations are summarized in the table below. In the table: “426 g/L SC” refers to a crystalline indoxacarb suspension concentrate prepared according to example 1; “322.6 g/L, SC” refers to a suspension concentrate containing prior art crystalline indoxacarb; and “EC” refers to a prior art indoxacarb emulsion concentrate containing 0.15 kg/L amorphous indoxacarb:

| Test | Indoxacarb | Rate (ppm) | Description |
|---|---|---|---|
| 1 | — | — | Untreated control |
| 2 | 426 g/L SC | 47.8 | Foliar application |
| 3 | 426 g/L SC | 15.9 | Foliar application |
| 4 | 426 g/L SC | 5.3 | Foliar application |
| 5 | 426 g/L SC | 1.8 | Foliar application |
| 6 | 322.6 g/L SC | 47.8 | Foliar application |
| 7 | 322.6 g/L SC | 15.9 | Foliar application |
| 8 | 322.6 g/L SC | 5.3 | Foliar application |
| 9 | 322.6 g/L SC | 1.8 | Foliar application |
| 10 | 0.15 kg/L EC | 47.8 | Foliar application |
| 11 | 0.15 kg/L EC | 15.9 | Foliar application |
| 12 | 0.15 kg/L EC | 5.3 | Foliar application |
| 13 | 0.15 kg/L EC | 1.8 | Foliar application |
| 14 | 426 g/L SC | 430 | Foliar application, 2 hour drying, 7.6 cm rainfall |
| 15 | 426 g/L SC | 143.3 | Foliar application, 2 hour drying, 7.6 cm rainfall |
| 16 | 426 g/L SC | 47.8 | Foliar application, 2 hour drying, 7.6 cm rainfall |
| 17 | 426 g/L SC | 15.9 | Foliar application, 2 hour drying, 7.6 cm rainfall |
| 18 | 322.6 g/L SC | 430 | Foliar application, 2 hour drying, 7.6 cm rainfall |
| 19 | 322.6 g/L SC | 143.3 | Foliar application, 2 hour drying, 7.6 cm rainfall |
| 20 | 322.6 g/L SC | 47.8 | Foliar application, 2 hour drying, 7.6 cm rainfall |
| 21 | 322.6 g/L SC | 15.9 | Foliar application, 2 hour drying, 7.6 cm rainfall |
| 22 | 0.15 kg/L EC | 430 | Foliar application, 2 hour drying, 7.6 cm rainfall |
| 23 | 0.15 kg/L EC | 143.3 | Foliar application, 2 hour drying, 7.6 cm rainfall |
| 24 | 0.15 kg/L EC | 47.8 | Foliar application, 2 hour drying, 7.6 cm rainfall |
| 25 | 0.15 kg/L EC | 15.9 | Foliar application, 2 hour drying, 7.6 cm rainfall |

The results are reported in the table below where: “Rate” refers to the application rate, “Dead” refers to the number of dead insects, and “Total” refers to the total number of insects applied per test.

| Test | Indoxacarb | | Rate (ppm) | Washoff | Dead | Total | Mortality |
|---|---|---|---|---|---|---|---|
| 1 | — | | — | No | 0 | 32 | 0% |
| 2 | 426 | g/L SC | 47.8 | No | 32 | 32 | 100% |
| 3 | 426 | g/L SC | 15.9 | No | 31 | 32 | 96.9% |
| 4 | 426 | g/L SC | 5.3 | No | 25 | 32 | 78.1% |
| 5 | 426 | g/L SC | 1.8 | No | 6 | 32 | 8.8% |
| 6 | 322.6 | g/L SC | 47.8 | No | 32 | 32 | 100% |
| 7 | 322.6 | g/L SC | 15.9 | No | 30 | 32 | 93.8% |
| 8 | 322.6 | g/L SC | 5.3 | No | 21 | 32 | 65.6% |
| 9 | 322.6 | g/L SC | 1.8 | No | 0 | 32 | 0% |
| 10 | 0.15 | kg/L EC | 47.8 | No | 32 | 32 | 100% |
| 11 | 0.15 | kg/L EC | 15.9 | No | 30 | 32 | 93.8% |
| 12 | 0.15 | kg/L EC | 5.3 | No | 16 | 32 | 50% |
| 13 | 0.15 | kg/L EC | 1.8 | No | 10 | 32 | 31.3% |
| 14 | 426 | g/L SC | 430 | Yes | 31 | 32 | 96.9% |
| 15 | 426 | g/L SC | 143.3 | Yes | 31 | 32 | 96.9% |
| 16 | 426 | g/L SC | 47.8 | Yes | 14 | 32 | 43.8% |
| 17 | 426 | g/L SC | 15.9 | Yes | 5 | 32 | 15.6% |
| 18 | 322.6 | g/L SC | 430 | Yes | 32 | 32 | 100% |
| 19 | 322.6 | g/L SC | 143.3 | Yes | 31 | 32 | 96.9% |
| 20 | 322.6 | g/L SC | 47.8 | Yes | 12 | 32 | 37.5% |
| 21 | 322.6 | g/L SC | 15.9 | Yes | 7 | 32 | 21.9% |
| 22 | 0.15 | kg/L EC | 430 | Yes | 31 | 32 | 96.9% |
| 23 | 0.15 | kg/L EC | 143.3 | Yes | 8 | 32 | 25% |
| 24 | 0.15 | kg/L EC | 47.8 | Yes | 2 | 32 | 6.3% |
| 25 | 0.15 | kg/L EC | 15.9 | Yes | 0 | 32 | 0% |

The results are displayed in the table below in terms of LC₅₀ and LC₉₀ where “LC₅₀” and “LC₉₀” refer to the concentration in ppm at which 50% and 90% insect lethality, respectively, is achieved.

| | | | LC₅₀ | | | LC₉₀ | | |
|---|---|---|---|---|---|---|---|---|
| Indoxacarb | | Washoff | Ave | Lower | Upper | Ave | Lower | Upper |
| 426 | g/L SC | No | 3.3 | 2.5 | 4.2 | 8.5 | 6.3 | 14.4 |
| 322.6 | g/L SC | No | 5.0 | 4.0 | 6.2 | 10.6 | 8.2 | 16.4 |
| 0.15 | kg/L EC | No | 3.8 | 2.6 | 5.1 | 15.2 | 10.4 | 28.7 |
| 426 | g/L SC | Yes | 45.3 | 33.6 | 59.7 | 153.9 | 108.4 | 269.6 |
| 322.6 | g/L SC | Yes | 42.6 | 14.0 | 129.9 | 136.2 | 24.5 | 755.3 |
| 0.15 | kg/L EC | Yes | 175.8 | 140.0 | 221.6 | 399.5 | 301.7 | 639.3 |

The results show that there were no significant differences in dry potency, but there were significant differences under washoff conditions. The SC formulations provided higher efficacy under washoff conditions as compared to the EC formulation (the EC₅₀ confidence intervals do not overlap). The two SC formulations (the 426 g/L formulation containing crystalline indoxacarb prepared according to the process of the present disclosure and the 322.6 g/L formulation containing crystalline indoxacarb prepared according to a prior art process) showed greater efficacy (i.e., had lower LC values) than the prior art EC formulation. The results further show that there was no significant difference between the 426 g/L SC formulation of the present disclosure and the 322.6 g/L prior art SC formulation.

This written description uses examples to illustrate the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A process of preparing an aqueous suspension of organic pesticides, the process comprising
I) forming a mixture comprising a source of at least one amorphous organic pesticide, water, and at least one formulation additive;
II) adding at least one crystalline seed of organic pesticide to the mixture;
III) crystallizing the at least one amorphous organic pesticide;
IV) optionally homogenizing the mixture;
V) optionally milling the mixture; and
VI) optionally thickening the mixture.

2. A process of preparing an aqueous suspension of organic pesticides, the process comprising
I) forming a mixture comprising
A) a formulation additive,
B) at least one crystalline organic pesticide, and
C) water;
II) adding at least one amorphous organic pesticide to the mixture under conditions of agitation;
III) crystallizing the at least one amorphous organic pesticide;
IV) optionally homogenizing the mixture;
V) optionally milling the mixture; and
VI) optionally thickening the mixture.

3. The process of claim 1 or claim 2, wherein the formulation additive is selected from additional water, dispersants, anti-freeze agents, viscosity-modifying agents, antifoams, bactericides, surfactants, and combinations thereof.

4. The process of any one of claims 1-3, wherein the at least one amorphous organic pesticide has a melting point in the range of from about 55° C. to about 100° C.

5. The process of any one of claims 1-4, wherein the at least one amorphous organic pesticide has a solubility in water of from about 0.00 1 mg/L to about 100 mg/L at 25° C.

6. The process of any one of claims 1-5, wherein the at least one amorphous organic pesticide is in a form selected from a melt, a supercooled melt, a solid amorphous form, a liquid, a solution comprising an active ingredient and a water miscible solvent, and combinations thereof.

7. The process of any one of claims 1-6, wherein the at least one amorphous organic pesticide is selected from the group consisting of insecticides, fungicides, herbicides, and any combination thereof.

8. The process of claim 7, wherein the insecticide is selected from the group consisting of: indoxacarb, bifenthrin, gamma-cyhalothrin, and combinations thereof.

9. The process of claim 7, wherein the fungicide is selected from the group consisting of: difenoconazole, pyraclostrobin, picoxystrobin, and combinations thereof.

10. The process of claim 7, wherein the herbicide is selected from the group consisting of: beflubutamid, s-beflubutamid, rimisoxamid, bixlozone isoflex, napropamide, aclonifen, and combinations thereof.

11. The process of any one of claims 1 to 10 wherein the aqueous suspension of organic pesticides further comprises a safener.

12. The process of claim 11, wherein the safener is Cloquintocet-mexyl.

13. The process of any one of claims 1-12, wherein the at least one crystalline organic pesticide has a melting point of from about 55° C. to about 100° C.

14. The process of claim 13, wherein the at least one crystalline organic pesticide has a melting point of about 95° C.

15. The process of any one of claims 1-14, wherein the at least one crystalline organic pesticide has a solubility in water of from about 0.001 mg/L to about 100 mg/L at 25° C.

16. The process of claim 15, wherein the at least one crystalline organic pesticide has a solubility in water of about 0.2 mg/L at 25° C.

17. The process of any one of claims 1-16, wherein the at least one crystalline organic pesticide is selected from insecticides, fungicides, herbicides, and combinations thereof.

18. The process of any one of claims 1-17, wherein the at least one crystalline organic pesticide is an insecticide.

19. An aqueous suspension of organic pesticides produced according to any one of claims 1-18.

20. An aqueous pesticide formulation produced according to any one of claims 1-18.
